(19) United States
(12) Patent Application Publication
(10) Pub. No.: US 2012/0159337 A1
(43) Pub. Date: Jun. 21, 2012

(54) System and method for recommending media content

(76) Inventors: Kerry Travilla, Chandler, AZ (US); Osama Al-Shaykh, San Diego, CA (US); Rick Schwartz, Carlsbad, CA (US); James Brailean, La Jolla, CA (US); Ralph Neff, San Diego, CA (US); Sanae Hotani, San Diego, CA (US)

(21) Appl. No.: 12/928,773

(22) Filed: Dec. 17, 2010

(51) Int. Cl. G06F 3/01

(52) U.S. Cl. 715/738

(57) ABSTRACT

A system and a method recommend media content. A recommending user may use a media-capable device to access, discover, identify and/or create the media content. The recommending user may use the media-capable device to generate, create and/or submit a recommendation based on the media content. The recommendation may identify media content to be consumed by one or more viewing users specified by the recommendation. A media experience engine may select, may obtain, may arrange and/or may organize the media content for a media experience session to be viewed by a group of viewing users. The media experience session may be based on the recommendation and the identities of the viewing users available to participate in the media experience session.

### BACKGROUND OF THE INVENTION

The present invention generally relates to a system and a method for recommending media content. More specifically, a recommending user may use a media-capable device to access, discover, identify and/or create the media content. The recommending user may use the media-capable device to generate, create and/or submit a recommendation based on the media content.

In the early days of audio media and visual media, few media rendering devices and limited media content choices were known. Analog radio was the first means of providing audio media. Then, early model televisions were developed. During that time, a family or a group of neighbors often gathered by a single television or analog radio device at the same time every week to watch or to listen to a favorite show. Thus, the limited technology of the early days brought people together for a shared media experience.

Modern technology creates a very different scenario. Modern digital media technology provides users with a large array of features and options and an unprecedented amount of available media content. However, the resulting media experience may be complex and may be fragmented across multiple media sources and/or devices. Further, modern digital media technology is typically focused on “media personalization” such that each individual user is provided with media content tailored to their tastes and/or preferences. Media personalization may be performed in an automated fashion based on expressed preferences or observed media consumption habits of a user or by providing the user with advanced media search and exploration tools. As a result, the user may obtain highly personalized media content which may be consumed on a personal media device, such as a mobile phone or a portable media player. In contrast to the early days of audio media and visual media, modern digital media technology tends to separate people into their own individual media worlds rather than bringing people together for a shared media experience.

Modern digital media technology provides techniques to share media with other users, to recommend media to friends, and to discuss media on fan websites and on more general social networking sites. However, these techniques provide a separated media experience which merely connects the individual users by electronic communication. Thus, a media recommendation by one user may cause one or multiple recipients of the recommendation to examine, consume and/or purchase the recommended media; however, each user typically has a separate experience undertaken individually by each of the recipients of the recommendation.

Therefore, sharing techniques based on “user-to-user communication” do not address the issue of bringing the users together at the same time and/or in the same place for a shared media experience. To understand this problem in more detail, one must understand the experience provided by modern digital media technology. Digital media conveys information to the media user. Digital media may include audio content, image content, video content, text content, or combinations of these basic media types. Digital music files, digital photographs, digital video files, digital articles, e-books and web pages are examples of digital media.

Media users may use multiple media-capable devices to access various media sources using different discovery tools. For example, a media user may have and/or may use a television, a set-top box, a networked gaming console, a desktop PC, a laptop PC and/or a mobile device to discover and/or consume media content. Media-capable mobile devices may include mobile phones, personal digital assistants (PDA's), digital cameras, camcorders, portable gaming devices, laptop PC's and/or the like. The various media-capable devices may be used in various locations by a user. For example, a user may have a television and a set-top box in the home, a desktop PC in the office, and a laptop computer and a mobile phone which may be carried anywhere. A media user may use these devices to encounter media content at any time of the day and in almost any location.

The media-capable devices of the media user may be used to access various media sources, such as locally stored media files, optical media discs, internet media sites, broadcast media content, video-on-demand services, Internet Protocol Television (IPTV) services, and/or the like. Locally stored media files may, for example, have user-generated media content, such as digital photographs and/or camcorder footage. Locally stored media files may also have, for example, files previously extracted from optical media discs, files previously retrieved from internet media sites, and/or files previously recorded from a broadcast service or other media service using a PC or a Digital Video Recorder (DVR) device. Optical media discs may, for example, include CD's, DVD's, Blu-Ray Discs, enhanced and/or writeable versions of any of these disc types, and other similar optical media formats. An internet media site may be, for example, a music site, a video sharing site, a photo sharing site, a social networking site, a news site, a commercial content site, and/or the like. A broadcast media content service provides real-time delivery of multiple simultaneous content channels which may be, for example, a terrestrial broadcast, a satellite broadcast, or a cable television service. Content services may be free services, may require the media user to pay for individual media programs, or may require the media user to pay recurring subscription fees.

A media user may browse, discover and/or select media content to consume using various media discovery tools. For example, local files may be used by the file browser of a device operating system or by a special application designed to discover, manage, and/or play media files. Internet media sites are typically accessed using a web browser which may be pre-installed on a media-capable device before the media user purchases the device or which may be installed later by the media user. Broadcast media services, such as satellite or cable television, typically have their own browsing and discovery tools which may, for example, be pre-installed on a set-top box provided to the media user. The browsing and discovery tools for broadcast media may be as simple as a dedicated guide channel which displays a slowly scrolling program grid. The browsing and discovery tools for broadcast media may have advanced tools, such as an interactive Electronic Program Guide (EPG) and/or a program search tool.

Of course, a media user may encounter media content through means other than the media-capable devices of the media user. For example, the media user may hear a song played in a bar or on an analog radio. As another example, the media user may discover an interesting TV program while watching television at a house of a friend or while watching a public television in a restaurant or an airport terminal. As yet another example, the media user may see an advertisement or a “coming attractions” preview of an interesting movie or television show while the media user is watching a movie in a movie theater. For the current discussion, media content identified using the media-capable devices of the media user is referred to as “internal” media content, and media content identified using other means is referred to as “external” media content.

A typical media user may access multiple media sources on different media-capable devices at different times and/or different locations during the day. For example, a media user named Alice may have a satellite broadcast service and an associated DVR-equipped set-top box at home. Further, Alice may have a laptop PC which travels with her between her home and her office. Still further, Alice may have a high-end smartphone capable of web browsing and media playback. On a typical day, Alice may watch a morning news show from the satellite broadcast service at home while eating breakfast, and then listen to analog radio in the car on her way to work. At lunchtime, Alice may take a break to browse a few favorite websites, such as a video sharing site and a social networking site, on her laptop PC. In the evening, Alice may listen to music, watch a DVD or watch recorded programs from her DVR-equipped set-top box. At various times of the day, Alice may use her smartphone to check email or browse the web. In any of these various activities, Alice may discover media content.

As a result, Alice may encounter interesting media content at various times of the day, in various locations, and using various media-capable devices and discovery tools. If Alice discovers media content that she likes, she has various options for sharing the discovery with other users, such as her family, friends and/or work colleagues. For example, she may send an email and/or an instant message using her laptop PC or her smartphone. Alternatively, she may utilize social networking sites, such as Twitter (trademark of Twitter, Inc.) or Facebook (trademark of Facebook, Inc.), to send a communication about the shared media. Alice may be able to identify the media by providing a direct link to the media or by attaching the media to the communication. As a result, a recipient of the communication may easily access the recommended media.

However, the feasibility of identifying the media depends on the source of the media and the means by which Alice communicates the recommendation. For media discovered using the internet, internet media sites typically provide controls which enable sharing of media links. However, other media sources, such as broadcast services or external media sources, may not provide means for sharing media links. Other media sources may not provide means for discovering the media links which may then be shared using a communication method not provided by the media source. In some cases, a media user may be limited to communicating available information using a generic communication method, such as email, instant messaging, text messaging or a social networking site. For example, Alice may send an email to her friends to describe a new television show she discovered through the program guide of her satellite broadcast service despite the satellite broadcast service not providing a method for sharing or recommending media content. However, this fallback form of sharing is less than ideal because easy access to the media is not provided.

Thus, the current state of technology for media discovery, access, consumption and recommendation does not provide a common framework for media sharing. The typical patchwork of media sources, media-capable devices and media discovery tools presents an inconsistent experience. A media user may find media content from some sources easy to share, but may find media content from other sources inconvenient or impossible to share.

Moreover, the existing technology for media discovery, access, consumption and recommendation typically provides sharing through user-to-user communication about the recommended media content. Such techniques may support an individual, personal media consumption experience for a user or users which receive the sharing communication. However, such techniques fail to address the more difficult problem of bringing multiple users together for a shared media experience. This problem is more difficult because bringing multiple users together typically requires recommendation and/or selection of media suitable for a group of users where the composition of the group may not be known in advance.

In the early days of radio and television, people regularly enjoyed shared media experiences despite, or perhaps because of, the few available devices and the limited content choices. A more modern solution is needed to provide a shared media experience for a group of modern users given the nearly unlimited content options available today.

### SUMMARY OF THE INVENTION

The present invention generally relates to a system and a method for recommending media content. More specifically, a recommending user may use a media-capable device to access, discover, identify and/or create the media content. The recommending user may use the media-capable device to generate, create and/or submit a recommendation based on the media content. The recommendation may identify media content to be consumed by one or more viewing users specified by the recommendation.

It is, therefore, an advantage of the present invention to provide a system and a method for recommending media content.

Another advantage of the present invention is to provide a system and a method which provide a common framework for recommending media which may originate from different media content sources.

And, another advantage of the present invention is to provide a system and a method which provide a common framework for recommending media where such framework is available to a recommending user on different media-capable devices of the user.

A further advantage of the present invention is to provide a system and a method which provide a common framework for recommending media where such framework is available to a recommending user across different media discovery tools.

Another advantage of the present invention is to provide a system and a method for recommending media content which select media content suitable for a plurality of users in a shared media experience session.

Yet another advantage of the present invention is to provide a system and a method for recommending media content which select media content suitable for multiple users in a shared media experience session based on multiple media content recommendations targeting one or more of the multiple users.

A further advantage of the present invention is to provide a system and a method for recommending media content which select media content suitable for multiple users in a shared media experience session based on media preferences associated with one or more of the multiple users.

Another advantage of the present invention is to provide a system and a method for recommending media content which select media content suitable for multiple users in a shared media experience session based on media restrictions associated with one or more of the multiple users.

Yet another advantage of the present invention is to provide a system and method for recommending media content which select media content suitable for multiple users in a shared media experience session based on a media experience session template.

Another advantage of the present invention is to provide a system and a method for recommending media content which select media content suitable for multiple users in a shared media experience session based on an anniversary date relevant to one or more of the multiple users.

And, another advantage of the present invention is to provide a system and a method for recommending media content which select media content suitable for multiple users in a shared media experience session based on a scheduled event relevant to one or more of the multiple users.

Yet another advantage of the present invention is to provide a system and a method for recommending media which create, track and resolve media content recommendations for multiple users.

A further advantage of the present invention is to provide a system and a method for creating, tracking and resolving media content recommendations for multiple users where each media content recommendation is a recommendation for a set of one or more users to consume a media content object.

Another advantage of the present invention is to provide a system and a method for creating, tracking and resolving media content recommendations for multiple users where the resolution of a media content recommendation may occur when each user in a set of one or more users consumes a recommended media content object.

Moreover, another advantage of the present invention is to provide a system and a method for creating, tracking and resolving media content recommendations for multiple users where resolution of a media content recommendation may occur based on one or more shared media experience sessions organized based on the media content recommendation.

Additional features and advantages of the present invention are described in, and will be apparent from, the detailed description of the presently preferred embodiments and from the drawings.

### BRIEF DESCRIPTION OF THE DRAWINGS

FIGS. 1, 2a, 2b and 2c illustrate black box diagrams of a system 10 for recommending media content in embodiments of the present invention.

FIG. 3 illustrates a flowchart for a method for recommending media content in an embodiment of the present invention.

FIG. 4 illustrates an embodiment of the recommendation.

FIGS. 5, 6a, 6b, 7a, 7b, 7c, 7d, 7e and 7f illustrate embodiments of a user interface for creating, generating and/or submitting recommendations.

FIG. 8 illustrates a flowchart for a method for recommending media content in an embodiment of the present invention.

FIGS. 9a, 9b, 9c and 9d illustrate embodiments of a template for a media experience session.

FIG. 10 illustrates a recommendation partitioned into an equivalent set of one or more atomic recommendations in an embodiment of the present invention.

FIG. 11 illustrates a table of examples of recommendations used in generation of media experience sessions in an embodiment of the present invention.

FIGS. 12 and 14 illustrate tables of determination of relevancy of media content objects from the recommendations of FIG. 11 in an embodiment of the present invention.

FIG. 13 illustrates a list of media content objects for a proposed media experience session in an embodiment of the present invention.

FIG. 15 illustrates a proposed media experience session based on selection of relevant media content objects in an embodiment of the present invention.

### DETAILED DESCRIPTION OF THE PREFERRED EMBODIMENTS

The present invention generally relates to a system and a method for recommending media content. More specifically, one or more recommending users may use media-capable devices to access, discover, identify and/or create the media content. The one or more recommending users may use the media-capable devices to generate, create and/or submit recommendations based on the media content. Each of the recommendations may identify media content to be consumed by one or more viewing users specified by the recommendation.

A media experience engine may select, may obtain, may arrange and/or may organize the media content for a media experience session to be viewed by a group of the viewing users. The media experience session may be based on the recommendations and the identities of the viewing users available to participate in the media experience session. The media experience session may be based on other information, such as, for example, preferences of one or more of the viewing users, a media viewing history of one or more of the viewing users, media viewing restrictions associated with one or more of the viewing users, interactive input from one or more of the viewing users, an anniversary date associated with one or more of the viewing users, a schedule associated with one or more of the viewing users, an event associated with one or more of the viewing users, and/or a media experience session template.

The media experience engine may record information about the recommendations and the media experience sessions to determine whether specific users have viewed the media content recommended to them. The media experience engine may use the information to organize the media experience sessions. For example, the information may be used to ensure that each recommendation is resolved by the media content being viewed by each of the viewing users specified in the recommendation. As another example, the information may be used to select media content for a group of viewing users based on the unresolved content recommendations associated with the viewing users of the group.

The terms “view” and “viewing” are used generically herein to indicate the consumption of media content. The use of these terms is not limited to visual media content. A viewing session may have audio content in addition to visual content, and, in some embodiments, a viewing session may have audio content but not have visual content.

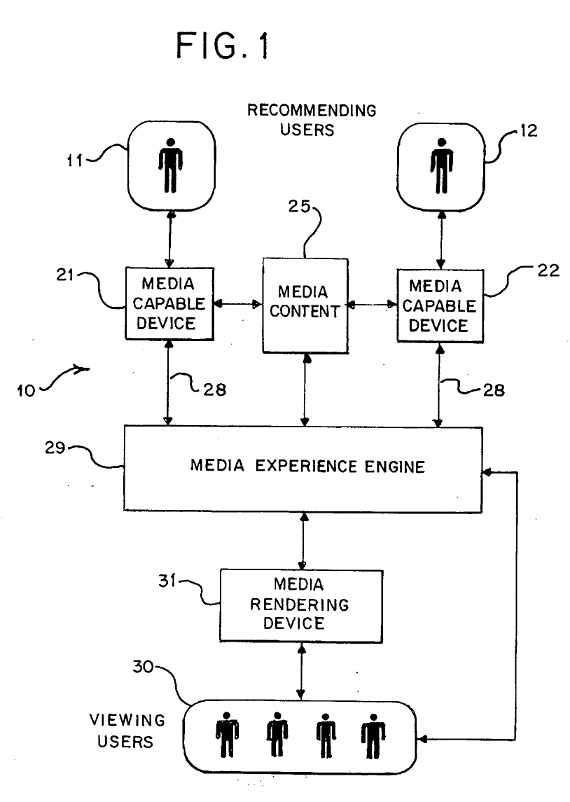

FIG. 1 generally illustrates a system 10 in an embodiment of the present invention. The system 10 may have a first recommending user 11 and/or a second recommending user 12 who may have a first media-capable device 21 and/or a second media-capable device 22, respectively. The first media-capable device 21 and/or the second media-capable device 22 may enable the first recommending user 11 and/or the second recommending user 12, respectively, to access, discover, identify and/or create media content 25.

The system 10 may have a media experience engine 29. The first media-capable device 21 and/or the second media-capable device 22 may enable the first recommending user 11 and/or the second recommending user 12, respectively, to submit a media content recommendation to the media experience engine 29. The recommendation may specify the media content 25 to be consumed by one or more specified users. The recommendation may have the media content 25 as a media content object, may have a link to a location where the media content 25 may be retrieved, and/or may have information describing the media content 25. If the recommendation has information describing the media content 25, the media experience engine 29 may use the information to search available media sources to locate and/or retrieve a version of the media content 25. The recommendation may have and/or may reference multiple media content objects. Additional details about the recommendation are provided hereafter.

The first media-capable device 21 and/or the second media-capable device 22 may be connected to the media experience engine 29 by a communication path 28. Therefore, the media experience engine 29 may receive the recommendation from the communication path 28. The communication path 28 may be any communication path which transfers digital information. For example, the communication path 28 may be a communication network, such as the internet, a home network, an 802.11 wireless network, a cellular telephone network, a wired Ethernet network, an ISDN network and/or the like. Alternatively, the communication path 28 may be a physical connection, such as, for example, a communication cable and/or a mobile device docking connector. The communication path 28 may span multiple networks and/or multiple physical connectors known to one skilled in the art. The first media-capable device 21 and the second media-capable device 22 may be connected to the media experience engine 29 by different communication paths which may be based on different technologies.

The media experience engine 29 may receive and/or may store the recommendation, and/or may accumulate multiple recommendations. The media experience engine 29 may process the multiple recommendations to create a media experience session for one or more viewing users 30 (hereafter “the viewing users 30”). The media experience engine 29 may select, may obtain, may arrange and/or may organize the media content 25 referenced by the recommendation 150 into a media experience session for a group of one or more of the viewing users 30. The media experience engine 29 may display the media experience session and/or the media content 25 associated with the media experience session on a media rendering device 31.

The first recommending user 11 and the second recommending user 12 may submit multiple recommendations using the same media-capable device. For example, the first recommending user 11 and the second recommending user 12 may submit multiple recommendations using the first media-capable device 21. Further, the first recommending user 11 and/or the second recommending user 12 may have access to multiple media-capable devices and/or may submit recommendations at any time using any of the multiple media-capable devices. The media experience engine 29 may create media experience sessions at various times for various groups of one or more of the viewing users 30. The system 10 may have any number of recommending users connected to the media experience engine 29, and the present invention is not limited to a specific number of recommending users. Further, the system 10 may have any number of viewing users of which any subset may gather into a group of viewing users to participate in a media experience session, and the present invention is not limited to a specific number of viewing users. In an embodiment, a user of the present invention may be a recommending user, a viewing user, or both. Moreover, the system 10 may have any number of media-capable devices, and the present invention is not limited to a specific number of media-capable devices.

The first media-capable device 21 and the second media-capable device 22 may be any device capable of creating, discovering, identifying and/or rendering the media content 25. For example, the first media-capable device 21 and/or the second media-capable device 22 may be a networked television, a set-top box, a networked gaming console, a desktop PC, a laptop PC, a mobile phone, a PDA, a digital camera, a camcorder, a portable gaming device and/or the like. The present invention is not limited to a specific embodiment of the first media-capable device 21 or the second media-capable device 22.

The first media-capable device 21 and/or the second media-capable device 22 may have media discovery tools, such as, for example, a web browser, a file browser, a media player, a media management application, an electronic program guide, a media search tool and/or the like. A media discovery tool may be a generic tool which is not affiliated with a specific media source and/or content provider. Alternatively, a media discovery tool may be provided by and/or may be affiliated with a specific media source and/or content provider. For a media discovery tool provided by and/or affiliated with a specific media source and/or content provider, the media discovery tool may be limited to discovering, accessing and/or using the media content 25 from the specific media source and/or content provider. A single media-capable device may include multiple media discovery tools. Further, a single media-capable device may be capable of accessing the media content 25 from multiple media sources and/or content providers.

The first media-capable device 21 and/or the second media-capable device 22 may have capabilities for generating, creating and/or submitting recommendations to the media experience engine 29 which specify the media content 25 to be consumed by one or more target users. Hereafter these capabilities are referred to as “recommendation capabilities.” The recommendation capabilities may be provided by a media discovery tool, and/or the recommendations may be based on the media content 25 accessed, discovered, identified and/or created using the media discovery tool. For example, a file browser may have the capability to create and/or submit a recommendation based on a media content file identified using the file browser. As another example, a web browser may have the capability to create and/or submit a recommendation based on the media content 25 displayed in and/or linked from a web page. As yet another example, a mobile camcorder application may have the capability to create and/or submit a recommendation based on a video file created by the mobile camcorder application. As a result, the various media discovery tools may be designed to cooperate with the media experience engine 29 to provide a recommending user with a convenient means to create and submit the recommendations.

Alternatively, the recommendation capabilities may be provided by a plug-in module which may be added to a media discovery tool having a plug-in architecture. For example, a browser plug-in may attach to an existing web browser on the first media-capable device 21, and/or the browser plug-in may provide the recommendation capabilities for the first media-capable device 21. The first recommending user 11 may obtain and/or may install the browser plug-in to upgrade an existing web browser with the ability to create and submit recommendations based on the media content 25 discovered and/or accessed using the web browser.

As yet another option, the recommendation capabilities may be provided by a separate recommendation application. A separate recommendation application may be employed, for example, if new or modified media discovery tools are not provided and/or if the media discovery tools do not support a plug-in architecture. The separate recommendation application may enable a user to browse and/or search for local media files, to access an electronic program guide associated with a broadcast provider or another content provider, to locate the media content 25 from internet content sites and/or services, and/or the like. Then, the separate recommendation application may enable the user to generate, create, and/or submit recommendations based on the media content 25 identified using the separate recommendation application.

The separate recommendation application may utilize information created by one or more of the media discovery tools which lack the recommendation capabilities. For example, the separate recommendation application may enable the user to paste a media link copied from a web browser which lacks recommendation capabilities. As another example, the separate recommendation application may have access to log files, “favorites” files and/or “history” files which may be produced by and/or may be associated with a web browser, a media player, a camcorder application or another media discovery tool. The separate recommendation application may parse such files to identify the media content 25 which may have been marked as a favorite by the user with one or more of the media discovery tools which lack the recommendation capabilities. Further, the separate recommendation application may parse such files to identify the media content 25 may have been recently identified, accessed, created and/or used by the user with one or more of the media discovery tools which lack the recommendation capabilities. Then, the separate recommendation application may provide a list of the media content 25, “favorite” media content 25 and/or “recently accessed” media content 25 and/or may enable the user to create and submit a recommendation based on the media content 25 selected from the list.

In addition, the separate recommendation application may enable the user to recommend external media content 25 by receiving information available about the external media content 25 from the user. This capability is described in more detail hereafter.

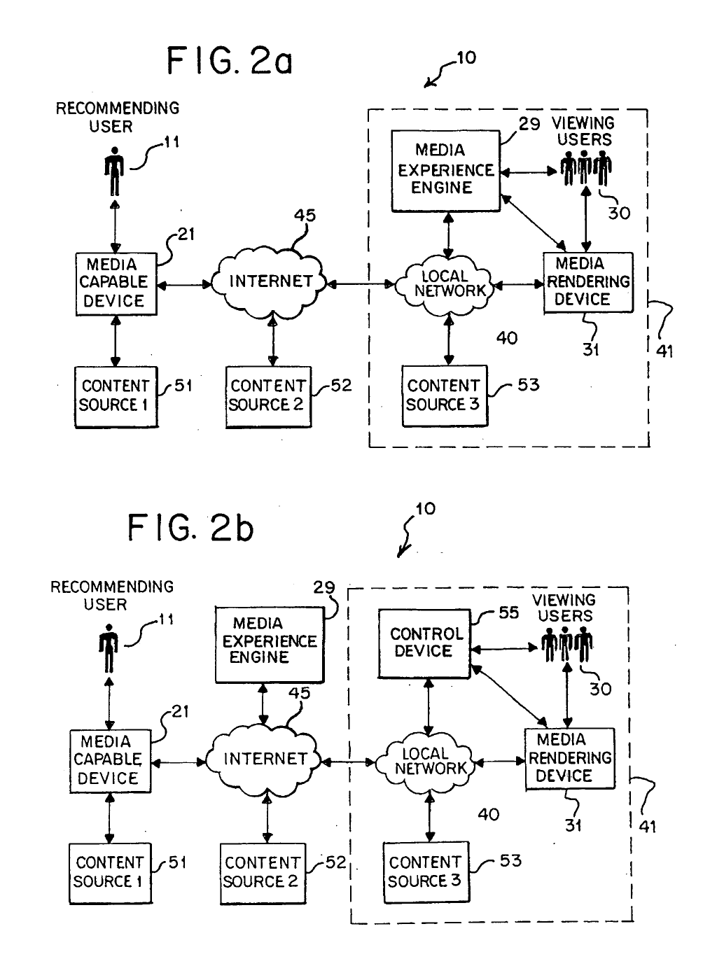

Referring again to FIG. 1, the media content 25 may be and/or may have audio content, video content, image content, text content, mixtures of these media content types, and/or the like. For example, the media content 25 may be and/or may have digital music files, digital photographs, digital video files, digital articles, e-books, online magazines, web pages, animations, vector graphic images and/or the like. As apparent from the preceding examples, the media content 25 may originate from multiple media sources and/or content providers. For simplicity, FIG. 1 does not show multiple sources of the media content 25; however, multiple sources of the media content 25 are illustrated in FIGS. 2a, 2b and 2c. For example, the media content 25 may originate from one or more internet content sites, one or more broadcast services, one or more file storage devices, one or more media servers, or any combination of such sources. The media content 25 may be created by a media-capable device, such as, for example, the first media-capable device 21 and/or the second media-capable device 22. For example, the media content 25 may be created using a photo capture application, a camcorder application and/or a media editing application.

Referring again to FIG. 1, the recommendation may provide information used by the media experience engine 29 to request, retrieve, obtain and/or search for the media content 25 specified by the recommendation. For example, the recommendation may have a direct link, such as, for example, an HTTP URL and/or an RTSP URL, which may be used to retrieve the media content 25. As another example, the recommendation may provide the media content 25. For example, a media content file may be included in and/or attached to a communication message conveying the recommendation. As yet another example, the recommendation may have descriptive information to search for, locate, and/or identify the media content 25 using one or more media sources and/or content providers accessible to the media experience engine 29. For example, the recommendation may specify a television show title, season, and episode number, such as “Lost, Season 7, Episode 12,” or a combination of broadcast service, channel number, date and time, such as “Time Warner San Diego, Channel 7, 7/2/2010, 8:00 pm.” Based on the descriptive information, the media experience engine 29 may utilize available information sources, media sources and/or content providers to locate, identify and/or obtain the media content 25 specified in the recommendation so that the media content 25 may be used in a media experience session.

The media experience engine 29 may be a dedicated consumer electronics appliance. For example, the media experience engine 29 may be a stand-alone electronic device which may be attached to a communication network and/or to a rendering device, such as, for example, a television. Alternatively, the media experience engine 29 may be rendering device, such as, for example, a television, a stereo, a set-top box, a gaming console and/or the like. As yet another alternative, the media experience engine 29 may be software executed by a computing device, such as, for example, a desktop personal computer, a laptop personal computer, a PDA, and/or a cell phone. The media rendering device 31 may be combined into the same device as the media experience engine 29. For example, the media experience engine 29 may be software executed by a laptop PC or a cell phone. Alternatively, the media rendering device 31 may be a separate device. For example, the media rendering device 31 may be a computer monitor, a set of speakers, a television and/or a stereo. The media rendering device 31 may be any device capable of rendering the media content 25 known to one skilled in the art, and the present invention is not limited to a specific embodiment of the media rendering device 31.

In some embodiments, the media experience engine 29 may not reside on a physical device at the location of the user. For example, the media experience engine 29 may be provided virtually in the form of a remote service accessible using a network. In this case, recommendations may be submitted to the remote service, and/or the remote service may create media experience sessions based on the recommendations submitted. For example, the remote service may provide the media experience sessions using a web page, and/or the viewing users 30 may view the media experience session using a media player embedded in the web page. As another example, the remote service may stream the media experience session to a set-top box, to a networked television, to a streaming media player application executed by a computing device, and/or the like. Thus, the present invention is not limited by the physical location of the media experience engine 29, and the present invention is not limited to a specific means for connecting the media experience engine 29 to the media rendering device 31.

FIG. 2a generally illustrates an embodiment of the system 10 in which the media experience engine 29 may create media experience sessions. As shown in FIG. 2a, the media experience engine 29 may be provided by a device in a local network 40. The local network 40 may be, for example, a home network, an office network, a campus network and/or the like. The local network 40 may be based on one or more common networking technologies; for example, the local network 40 may use one or more of Ethernet, Firewire, Multimedia over Coax, and/or Wi-Fi networking technologies. The present invention is not limited to these technologies, and the local network 40 may use any networking technologies known to one skilled in the art.

As generally illustrated in FIG. 2a, the media experience engine 29 and the media rendering device 31 may be connected by a direct connection and/or the local network 40. For example, the media experience engine 29 may be pre-installed on a consumer electronics device, such as, for example, a set-top box or a networked gaming console, which may be directly connected to a television by an HDMI cable. As another example, the media experience engine 29 may be software executed by a desktop personal computer which may be connected to a networked television by a home network.

The viewing users 30 may interact with the media experience engine 29 to configure and/or control the media experience engine 29. For example, one or more users may manage a media experience account, may establish and/or may maintain personal viewing preferences, may schedule an upcoming media experience session for a group of one or more of the viewing users 30, may request an immediate media experience session for a group of one or more of the viewing users 30, may specify and/or may edit a template used in a media experience session, and/or may control creation of and/or viewing of a media experience session. The media experience engine 29 and/or the device which hosts the media experience engine 29 may provide a user interface to support such configuration and/or control. Additional details about the interaction between the viewing users 30 and the media experience engine 29 are provided hereafter.

FIG. 2a generally illustrates that the first recommending user 11 may have the first media-capable device 21 connected to the media experience engine 29 by the internet 45 and/or the local network 40. Multiple recommending users may be connected to the media experience engine 29, and each of the multiple recommending users may have multiple media-capable devices. Further, other communication paths may enable a recommending user to submit a recommendation. For example, the first recommending user 11 and/or the first media-capable device 21 may be physically present at a site 41 where the viewing users 30 view a media experience session. The first recommending user 11 and/or the first media-capable device 21 may connect directly to the media experience engine 29 through the local network 40. As another example, the communication path 28 to the media experience engine 29 may involve a wide area network, such as, for example, a cell phone network and/or a WiMax network.

Multiple media sources and/or content providers may be available, such as, for example, a first content source 51, a second content source 52 and/or third content source 53. The first content source 51 may be a content source associated with the first media-capable device 21. For example, the first content source 51 may be internal memory and/or disk storage of the first media-capable device 21 and/or may be removable memory attached to the first media-capable device 21. The first content source 51 may be media files previously transferred to the first media-capable device 21, previously retrieved from internet content sources by the first media-capable device 21, and/or previously created by the first media-capable device 21. The first content source 51 may be an external storage device accessible to the first media-capable device 21, such as, for example, a hard drive and/or a media server device.

The second content source 52 may be a content source accessible using the internet 45. For example, the second content source 52 may be photo sharing site, a video sharing site, a music sharing site, a news information site, a sports information site, an online music service, an online video service and/or the like. The second content source 52 may be a “storage locker” service which may enable a user to store media content and/or other files for later retrieval and/or use. The second content source 52 may require an authorization, a subscription payment, a payment per media object, and/or some other form of payment to retrieve media.

The third content source 53 may be media storage present in and/or attached to the local network 40. For example, the third content source 53 may be a personal computer, a digital video recorder, a media server, a network attached storage device, a set-top box and/or the like. The third content source 53 may be media files previously retrieved from the internet 45, previously recorded from a broadcast service, previously transferred from a digital camcorder or digital camera, and/or the like. The third content source 53 may provide access to a content service; for example, the third content source 53 may be a set-top box through which a broadcast service and/or an IPTV service may be received.

One skilled in the art will recognize other content source locations and/or other suitable communication paths for accessing the content sources. For example, the device hosting the media experience engine 29 may be connected to a content source by a physical cable, an alternative network and/or some other communication path not including the local network 40. The device hosting the media experience engine 29 may have internal storage which may be used to store the media content. The present invention is not limited to the content sources and communication paths illustrated in FIGS. 2a and 2b.

Thus, the viewing users 30 may interact with the media experience engine 29 to request a media experience session to be generated and/or displayed on the media rendering device 31. The request may specify the viewing users 30 and/or a time duration for the media experience session. The request may specify other parameters for the media experience session, such as, for example, content preferences and/or a template. As a result, the media experience engine 29 may organize, may create and/or may generate a media experience session appropriate for the viewing users 30 and/or in accordance with the other information communicated in the request. The organization, creation and/or generation of the media experience session may be based on recommendations previously received by the media experience engine 29.

The media experience session may display media content specified in the media recommendations. The media experience engine 29 may process the recommendations to obtain, discover, locate and/or retrieve the media content. The processing may be performed in advance by the media experience engine 29, or the processing may be performed in response to the request from the viewing users 30. The media content may be sent to and/or may be rendered by the media rendering device 31 in the media experience session.

FIG. 2b generally illustrates an embodiment of the system 10 in which the media experience engine 29 may create media experience sessions. The overall structure of the embodiment of the system 10 depicted in FIG. 2b may be similar to the overall structure of the embodiment of the system 10 depicted in FIG. 2a. For example, the embodiment of the system 10 depicted in FIG. 2b may match the embodiment of the system 10 depicted in FIG. 2a in overall network topology; placement of the first recommending user 11 and/or the media-capable device 21 of the first recommending user 11; and/or the types and locations of the first content source 51, the second content source 52 and the third content source 53. However, the embodiment of the system 10 depicted in FIG. 2b may differ from the embodiment of the system 10 depicted in FIG. 2a in the location and/or the form of the media experience engine 29. As shown in FIG. 2b, the media experience engine 29 may be remote from the media rendering device 31 and/or the viewing users 30. For example, the media experience engine 29 may be a service accessible using the internet 45 as previously set forth.

Thus, the first recommending user 11 may use the first media-capable device 21 to access, discover and/or use media content from one or more media content sources. The first recommending user 21 may generate, may create and/or may submit recommendations based on the media content. The recommendations may be delivered to the media experience engine 29 using the internet 45. The media experience engine may collect multiple recommendations from multiple recommending users using the internet 45, and/or each of the multiple recommendations may specify media content to be consumed by one or more target users.

The viewing users 30 may seek to view a media experience session on the media rendering device 31. The viewing users may interact with the media experience engine 29 to configure and/or control the media experience engine 29 as previously set forth. To this end, the viewing users 30 may utilize a control device 55 connected to the media experience engine 29 by the internet 45 and/or the local network 40. The control device 55 may present a user interface which may enable interaction with the media experience engine 29 located remotely. For example, the control device 55 may be a set-top box and/or a networked gaming console which displays the user interface on an attached television and/or which enables control of the user interface using an infrared remote control and/or a game controller. As another example, the control device 55 may be a personal computing device, such as a laptop PC, a PDA or a cell phone. The personal computing device may display the user interface on a display screen and/or may utilize available user input mechanisms, such as a keyboard, a mouse, a keypad, a touchscreen, and/or the like. As a result, the viewing users 30 may interact with the user interface to configure and/or control the media experience engine 29 located remotely.

In an embodiment, the control device 55 may have a dedicated user interface for configuring and/or controlling the media experience engine 29. In another embodiment, the control device 55 may use a standard web browser to display a web page provided by the media experience engine 29. The web page may have control elements to enable configuration/or and control of the media experience engine 29. One skilled in the art will recognize that the user interface may vary in form to use resources, display capabilities and user input capabilities available on the control device 55. The present invention is not limited to a specific embodiment of the user interface of the control device 55.

The viewing users 30 may use the control device 55 to request generation and/or display of a media experience session on the media rendering device 31. As previously set forth, the request may specify the viewing users 30, a time duration for the media experience session, and/or other parameters, such as, for example, content preferences and/or a template. The control device 55 may communicate the request to the media experience engine 29 located remotely. As a result, the media experience engine 29 may organize, may create and/or may generate a media experience session appropriate for the viewing users 30 and/or in accordance with the other information communicated in the request. The organization, creation, and/or generation of the media experience session may be based on the recommendations previously received by the media experience engine 29.

The media experience engine 29 may transmit media content associated with the media experience session to the control device 55 and/or the media rendering device 31. The media content may be displayed and/or rendered on the media rendering device 31. As a result, the viewing users 30 may view the media experience session on the media rendering device 31.

The control device 55 and the media rendering device 31 may be two separate devices or may be a single device. The set-top box and gaming console examples described previously are examples of the control device 55 and the media rendering device 31 being two separate devices. As an additional example of the control device 55 and the media rendering device 31 being two separate devices, the control device 55 may be a desktop PC, and the media rendering device 31 may be an attached computer monitor with an audio speaker or audio speakers.

As an example of the control device 55 and the media rendering device 31 being a single device, the media rendering device 31 may be a networked television designed to interact with a media experience engine 29 provided by a remote service. The networked television may have built-in capabilities of the control device 55. As another example of the control device 55 and the media rendering device 31 being a single device, a laptop PC or other personal computing device may combine the functions of the control device 55 and the media rendering device 31. For example, both functions may be embedded in a web page provided by the media experience engine 29 located remotely, and/or the web page may be displayed by a web browser on the laptop PC or other personal computing device.

The remote media experience engine 29 may be capable of providing service to different viewing locations, and each of the different viewing locations may have a media rendering device and/or a control device. In this case, the viewing users 30 may gather at any of the different viewing locations to request, view and/or interact with a media experience session. Further, in this case, each of the viewing users 30 may not be restricted to any specific viewing location, local network or media rendering device.

FIG. 2c generally illustrates an embodiment of the system 10 in which the media experience engine 29 may create media experience sessions. The embodiment of the system 10 depicted in FIG. 2c may be similar in structure to the embodiment of the system 10 depicted in FIG. 2a and/or the embodiment of the system 10 depicted in FIG. 2b, but the embodiment of the system 10 depicted in FIG. 2c may vary in the form and/or the location of the media experience engine 29.

As generally illustrated in FIG. 2c, the media experience engine 29 may reside in the local network 40 and/or may be collocated with the media rendering device 31 at a site 41 where the viewing users 30 view a media experience session. However, the media experience engine 29 may be connected to a remote media experience support server 60. The media experience engine 29 may connect to the remote media experience support server 60 using the internet 45 and/or another network or combination of networks not shown.

The media experience support server 60 may be a single server device, or the function of the media experience support server 60 may be shared between multiple server devices. For example, the function of the media experience support server 60 may be provided by a server farm and/or a number of interconnected servers which may or may not be in the same physical location. The present invention is not limited to a specific device or devices which provide the function of the media experience support server 60 described herein.

The media experience support server 60 may support functions of the media experience engine 29. For example, the media experience support server 60 may collect the recommendations submitted by various recommending users and/or may deliver the recommendations to the media experience engine 29. Collection and/or delivery of the recommendations by the media experience support server 60 may be particularly useful if a firewall or other security provision prevents the media-capable devices from directly delivering the recommendations to the media experience engine 29 in a “push” fashion. Instead of directly delivering the recommendations from the media experience engine 29, the recommendations may be submitted to and/or collected by the media experience support server 60. The media experience engine 29 may contact the media experience support server 60 to request delivery of the recommendations. The request may be sent at periodic intervals and/or when a specific set of recommendations are needed by the media experience engine 29 to create a media experience session.

As another example, the media experience support server 60 may pre-process the recommendations to search for, identify, locate and/or retrieve the media content specified in the recommendations. As a result, the media experience support server 60 may perform tasks which would otherwise require computational effort by the media experience engine 29.

As a first example, the media experience support server 60 may receive a recommendation which contains descriptive information about the recommended media content but does not specify a direct link from which the recommended media content may be retrieved. The media experience support server 60 may use the descriptive information to locate the recommended media content using one or more content sources known to be available to the media experience engine 29. For example, the media experience support server 60 may execute content searches using one or more search interfaces provided by the content sources. As a result, the media experience support server 60 may obtain a direct link to retrieve the recommended media content from one of the content sources. Then, the media experience support server 60 may provide the direct link to the media experience engine 29 which may subsequently retrieve the recommended media content for inclusion in a media experience session.

As a second example, the media experience support server may receive multiple recommendations which specify different recommended media content objects. As previously set forth, recommendations may specify the recommended media content in various ways. For example, the recommendations may have the media content as media content objects, may have direct links to the media content, and/or may provide descriptive information for the media content. The media experience support server 60 may pre-process the recommendations to store the media content which is contained in the recommendations; to retrieve and store the media content for which a direct link is provided; and to locate, retrieve and store the media content for which descriptive information is provided. The media experience support server 60 may have data storage capabilities to store the recommended media content. Subsequently, the media experience support server 60 may deliver the media content to the media experience engine 29 for use in a media experience session. As a result, the media experience support server 60 may provide a single source for the media content which the media experience engine 29 may use in a media experience session.

Various combinations of these techniques may be used by the media experience support server 60. In a preferred embodiment, the media experience support server 60 may locally store the media content which is contained in and/or attached to the recommendations. For media content contained in and/or attached to the recommendations, the media experience support server 60 may act as a media server by creating and/or exposing direct links by which the media experience engine 29 may access, may download and/or may stream the media content. Further, the media experience support server 60 may identify and/or may obtain direct links to the media content described by the recommendations lacking direct links. As a result, the media experience support server 60 may provide direct links for the media content required by the media experience engine 29. The direct links provided by the media experience support server 60 may be a combination of the direct links specified in the recommendations, the direct links identified and/or obtained by the media support server 60 based on descriptive information provided by the recommendations, and/or the direct links exposed by the media experience support server 60 which direct to media content locally stored by the media experience support server 60.

The pre-processing of the recommendations by the media experience support server may reduce the implementation complexity and/or the computational load of the media experience engine 29. As a result, the media experience engine 29 may reside on a device which does not have significant computational power, which lacks the ability to store large media files, and/or which cannot be continuously powered and/or continuously connected to a network to pre-process the recommendations and to obtain the media content in preparation for future media experience sessions.

The media experience support server 60 may provide service to different viewing locations, and each of the different viewing locations may have a media experience engine 29 and/or a media rendering device 31. As previously set forth for FIG. 2b, the viewing users 30 may gather at any of the different viewing locations to request, view and/or interact with a media experience session. As a result, the media experience engine 29 located at a site where the viewing users 30 view a media experience session may contact, may request information from, and/or may interact with the remote media experience support server 60. The media experience engine 29 may access information from the media experience server 60, such as, for example, the recommendations, the media content specified by the recommendations, and/or the pre-processing information produced by the media experience support server 60. The media experience engine 29 may use the information accessed from the media experience support server 60 to select, obtain, arrange and/or organize media content into a media experience session for the viewing users 30.

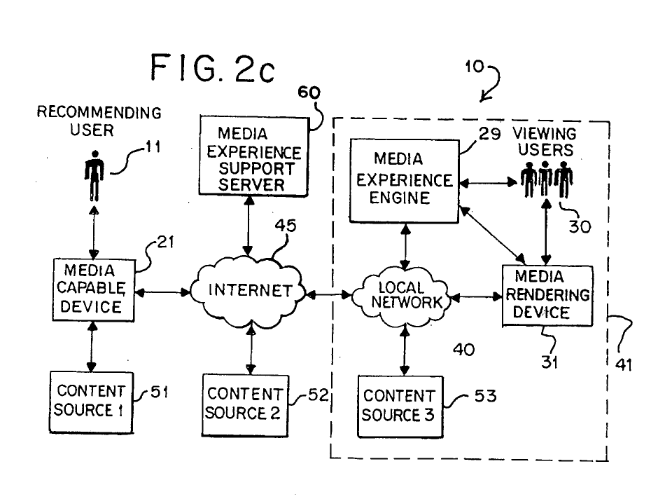

FIG. 3 generally illustrates a method 100 in an embodiment of the present invention. At step 102, the first recommending user 11 may identify media content using the first media-capable device 21. At step 104, the first recommending user 11 may submit a recommendation which may specify media content to be consumed by one or more target users. Step 102 and/or step 104 may be repeated any number of times to submit multiple media content recommendations. Step 102 and step 104 may be repeated by the first recommending user 11 to submit multiple recommendations, and the first recommending user 11 may utilize multiple media-capable devices to submit the recommendations. Moreover, in a typical embodiment, step 102 and step 104 may be repeated by different recommending users, and each of the different recommending users may utilize one or multiple media-capable devices to submit the recommendations. For example, step 102 and step 104 may be repeated by the second recommending user so that the first recommending user 11 and the second recommending user 12 may each submit recommendations.

At step 106, the media experience engine 29 may create a media experience session for a group of viewing users 30 based on the submitted recommendations. For example, the media experience engine 29 may create a media experience session for the group of viewing users 30″based on the recommendations submitted by the first recommending user 11 and/or the second recommending user 12. One or more of the submitted recommendations may specify target users in the group of viewing users 30. Accordingly, the media experience engine 29 may create a media experience session for the group of viewing users 30 based on the submitted recommendations which specify target users in the group of viewing users 30.

The media experience session may have and/or may obtain media content recommended for and/or appropriate for viewing by each of the viewing users 30 which may be specified as target users by one or more of the submitted recommendations. At step 108, the group of viewing users 30 may view the media experience session. In an embodiment, the viewing users 30 may view the media experience session together on the same media rendering device 31. In another embodiment, the viewing users 30 may view the media experience session in separate locations using multiple media rendering devices 31.

Creation, generation and/or submission of the recommendations by the recommending users is discussed in more detail hereafter. As previously set forth, a recommending user may use a media-capable device to access, discover and/or use media content. Further, the recommending user may create, generate and/or submit a recommendation which specifies media content to be viewed by one or more viewing users. In a typical embodiment, the recommending user may generate the recommendation using recommendation capabilities provided by a media discovery tool, a plug-in to a media discovery tool, and/or a separate recommendation application. The recommendation may be submitted directly to the media experience engine 29 or may be submitted to an associated device, such as, for example, the media experience support server 60.

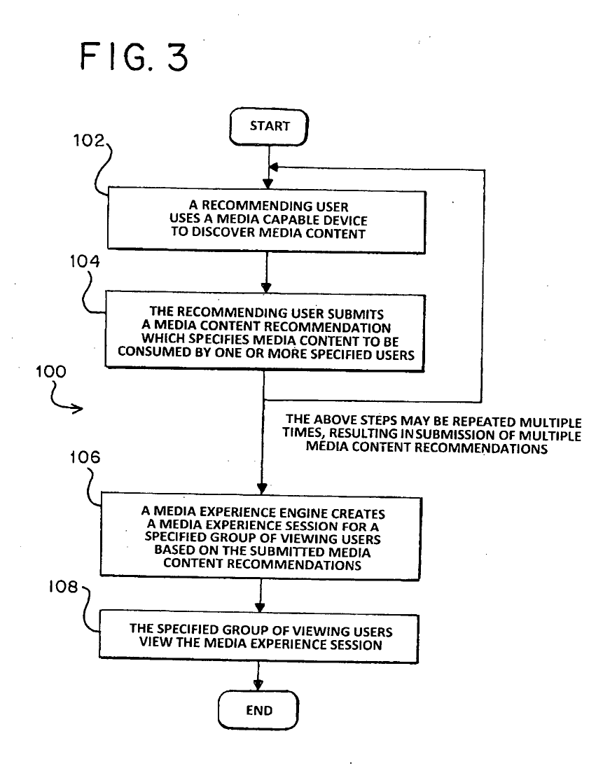

FIG. 4 generally illustrates an embodiment of a recommendation 150. The recommendation 150 may have information fields which may identify and/or may specify a recommending user, recommended content and/or a list of target users. The recommendation 150 may have one or more fields to specify content metadata and/or user markup. The recommendation 150 may have additional fields not shown in FIG. 4, and the present invention is not limited to the specific embodiment of the recommendation 150 depicted in FIG. 4.

A “Recommending User” field 152 may have an identification of the recommending user who created, generated and/or submitted the recommendation 150. The identification may be, for example, a proper name, a nickname, an email address, an account name, a unique identification number, an alphanumeric string and/or any other identification suitable for identifying the recommending user. The identification may have multiple parts; for example, the identification may have both a proper name for use in a human readable display and a unique identification number for unambiguously identifying the recommending user within a user pool.

A “Recommended Content” field 154 may specify the media content recommended for consumption by the target users. The media content may be specified by a direct link to the media content, the media content itself, and/or descriptive information for the media content. A direct link may specify a location from which the media content may be retrieved. The direct link may be, for example, an HTTP URL, an RTSP URL, and/or a directory path and filename.

Descriptive information for the media content may have one or more sub-fields which may be used to search for, locate, access and/or retrieve the media content from one or more accessible content sources. For example, the descriptive information for the media content may have a content type, a title, a genre, a list of one or more actors, directors, or production companies, a network name, a cable provider, a channel number, a broadcast date, a broadcast time, a season year, an episode number, a radio station, a band name, an artist name, an album name, a song name, a music label and/or the like. The descriptive information of the media content may be sufficient to identify the media content of the recommendation unambiguously or with a high degree of confidence. If the descriptive information of the media content is not sufficient to identify the media content of the recommendation unambiguously or with a high degree of confidence, the media experience engine 29 and/or the media experience support server 60 may use the “Recommending User” field 152 to contact the recommending user for additional descriptive information. Further, if the descriptive information of the media content is not sufficient to identify the media content of the recommendation unambiguously or with a high degree of confidence, the media experience engine 29 and/or the media experience support server 60 may use the identification in the “Recommending User” field 152 to request the recommending user to disambiguate a list of media content objects which are each compatible with the descriptive information previously provided.

The media content itself may be provided by the recommendation 150. For example, the “Recommended Content” field 154 may have a media content object, such as a digital photograph, a digital video file, a digital audio file, and/or the like. The media content object may be integrated into the recommendation 150 and/or may be attached to a message which conveys the recommendation 150. For example, the media content object may be a media file attached to an email message which conveys the recommendation 150, and/or the “Recommended Content” field 154 may refer to the media file attached to the email message.

The “Recommended Content” field 154 may specify multiple recommended media content objects using one or more of the specification types noted previously. For example, the “Recommended Content” field 154 may specify a direct link to a first video file, a direct link to a second video file, and/or descriptive information for a third video file. As a result, multiple media content objects may be recommended to be consumed by the target users.

The “List of Target Users” field 156 may identify one or more target users recommended to consume the media content specified in the “Recommended Content” field 154. Each of the one or more target users may be identified in the same fashion and/or a similar fashion as described previously for the identification of the recommending user in the “Recommending User” field 152.

The recommendation 150 may have one or more “Content Metadata” fields 158 which may provide metadata for the media content recommended if the metadata is available when the recommendation 150 is created, generated, or submitted. For example, the metadata may specify a playback duration, a file format, a compression format, a video resolution, an audio sampling rate, the date and/or the time the media content was created, a time when the media content becomes available, a time after which the media content is not available, and/or the like. The metadata may specify the descriptive information, such as, for example, a title, a genre, a list of one or more actors, directors, and/or production companies, a copyright date, an original air date and/or time, a season year, an episode number, a band name, an artist name, an album name, a song name, a music label, a rating and/or the like. The one or more “Content Metadata” fields 158 may provide metadata for different media content objects, and/or the metadata may be separated into different descriptions for each of the different media content objects. The one or more “Content Metadata” fields 158 may be used by the media experience engine 29 to arrange, organize, access and/or schedule the media content recommended into a media experience session. Further, the one or more “Content Metadata” fields 158 may be used to display messages and/or data about the media content in the media experience session.

The recommendation 150 may have one or more “User Markup” fields 160 which may provide input from the recommending user. The input may be integrated into the media experience session. The one or more “User Markup” fields 160 may have a text comment, a recorded audio comment, a recorded video comment and/or the like. For example, the recommending user may type a text comment, such as “Carla is going to love this video,” when creating and/or submitting a recommendation 150 for an online video identified while browsing a video sharing site using a laptop PC. The text comment may be provided in the one or more “User Markup” fields 160 and/or may be displayed by the media experience engine 29 when displaying the recommended online video in the media experience session.

As a further example, the recommending user may use a media-capable mobile device to create a photo slideshow using digital photos captured using the media-capable mobile device. Then, the recommending user may use the recommendation capabilities of the media-capable mobile device to create a recommendation 150 which includes the photo slideshow. The recommendation capabilities may enable the recommending user to film a video introduction to be included in the recommendation 150 in the one or more “User Markup” fields 160. After specifying the photo slideshow and/or the target users, the recommending user may use the video camera of the mobile device to film the video introduction. For example, the video introduction may be video of the recommending user saying “Hey gang! Here are the pictures I took the last few days in Yellowstone. Wish you were here to see it!”

Then, the recommendation 150 may provide the short video introduction in the one or more “User Markup” fields 160. For example, the one or more “User Markup” fields 160 may specify a direct link to a location from which the short video introduction may be retrieved, may have the short video introduction as an embedded video file, and/or may refer to a video file which encodes the short video introduction and may be attached to the message which conveys the recommendation 150. The media experience engine 29 may then display the short video introduction when displaying the photo slideshow in the media experience session.

The recommendation 150 may have additional fields not shown in FIG. 4. In an embodiment, the recommendation 150 may have a field which specifies a requirement that two or more of the target users must view the recommended media content together at the same time and/or in the same physical location. In an embodiment, the recommendation 150 may have a field which specifies a requirement that the recommended media content be shown exclusively to the specified target users. In an embodiment, the recommendation 150 may have a field which specifies a due date by which the recommended media content must be viewed by all of the target users. In an embodiment, the recommendation 150 may have a field which specifies whether the recommendation 150 is of high priority or low priority. In an embodiment, the recommendation 150 may have a field which specifies a list of users and/or a description of users to which the recommended media content must not be shown. For example, the recommendation 150 may specify that the recommended media content not be shown to a type of user, such as male users, female users or users under a specified age.

The embodiment of the recommendation 150 generally illustrated in FIG. 4 may be conveyed in a message. For example, a message from the recommending user and/or the media-capable device which generates the recommendation 150 may convey the recommendation 150 to a remotely located media experience engine 29. One skilled in the art will recognize many different messaging technologies and encapsulation protocols which may be used to deliver the recommendation 150. For example, the recommendation 150 may be conveyed using an email message, a Multimedia Messaging Service (MMS) message, a file transfer protocol, an HTTP POST body, a proprietary payload format carried in one or more TCP packets, and/or the like. The present invention is not limited to a specific technology by which recommendation 150 may be conveyed, and the recommendation 150 may be conveyed using any technology known to one having ordinary skill in the art.

The recommendation 150 may be generated based on user input entered by the recommending user into a user interface provided by the media experience engine 29 and/or a related device, such as, for example, the control device 55. For example, the media experience engine 29 may be installed on and/or provided by a set-top box. The user interface of the set-top box may enable the recommending user to select media content available to the set-top box and/or create, generate and/or submit a recommendation 150 based on the media content. As a result, the recommendation 150 may be directly available to the media experience engine 29 without being conveyed as a message.

As previously set forth, the recommendation 150 may be created, may be generated and/or may be submitted using the recommendation capabilities of a media-capable device, a media discovery tool and/or a separate recommendation application. Several illustrative user interface examples for creating these embodiments of the recommendation 150 are described hereafter.

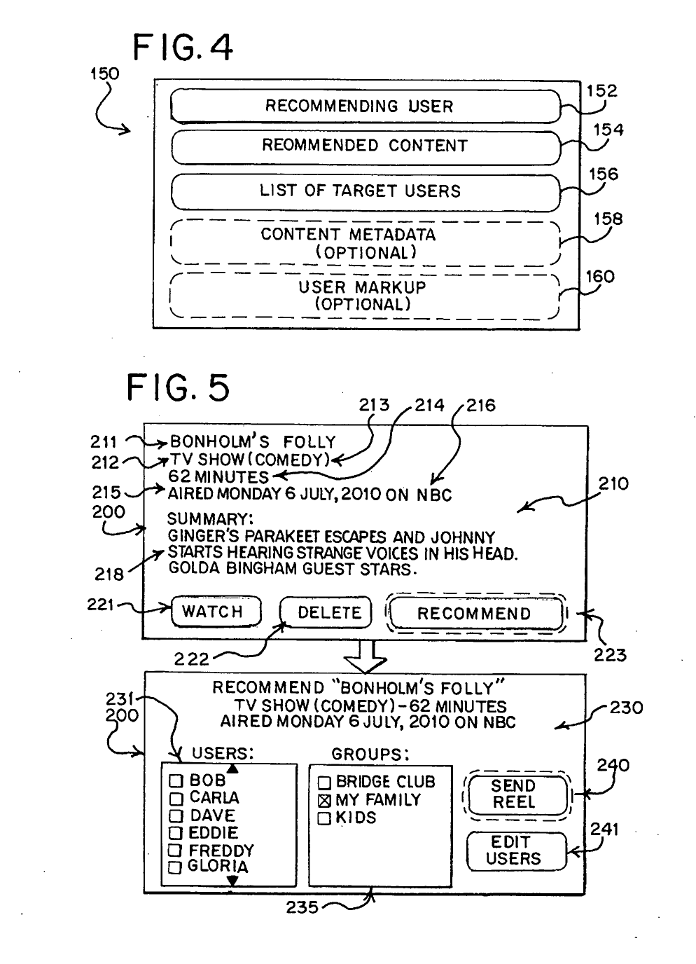

FIG. 5 generally illustrates an embodiment of a user interface 200 for creating, generating and/or submitting recommendations. The user interface 200 may be suitable for a device with a limited function remote control, such as, for example, a networked television, a set-top box, a Digital Video Recorder (DVR) device and/or a Home Theater Personal Computer (HTPC). Such devices may have a remote control which relies primarily on directional buttons for navigation, such as, for example, an up button, a down button, a left button, and a right button. Further, the remote control may have an action button, such as, for example, an “OK” button and/or an “Enter” button, which may initiate and/or confirm actions for a selected object or control. Such devices may lack more precise user input mechanisms, such as, for example, mouse control or a touchscreen.

The user interface 200 may display a detail information screen 210 for a selected media content object. One skilled in the art will recognize that the detail information screen 210 may be displayed after selection of a media content object from an Electronic Program Guide, a file browser, a list of recorded programs, a list of available “on demand” video files, a list of songs, a list of music albums, and/or the like. Accordingly, the media content object described by the detail information screen 210 may be a movie, a live TV program, a recorded TV program, an “on-demand” video, a video clip, a digital audio file, a music album and/or the like. In FIG. 5, the media content object is a recorded television program; however, various other types of media content objects may be used with only minor changes to the detail information screen 210.

As shown in FIG. 5, the detail information screen 210 may display detail information for a recorded TV program, such as, for example, a title 211, a content type 212, a genre 213, a duration 214, an original air date and time 215, and/or the network and/or content provider 216. Further, the detail information screen 210 may display a summary and/or synopsis 218.

The detail information screen 210 may have action controls which may be selected and/or may be activated using the remote control. As shown in FIG. 5, a recommending user may use a “watch” control 221 to watch the recorded television program, may use a “delete” control 222 to delete the recorded TV program, and/or may use a “recommend” control 223 to recommend the recorded TV program to other users. FIG. 5 depicts the “recommend” control 223 as selected and/or activated by the recommending user.

After selection and/or activation of the “recommend” control 223, the user interface 200 may display a “create recommendation” screen 230 which may enable the recommending user to select target users and/or groups to whom the recommendation may be directed. The recommending user may use the remote control to navigate into a user selection box 231 to select one or more users from a list of users displayed by the “create recommendation” screen 230. The recommending user may use the remote control to navigate into a group selection box 235 to select one or more groups of users from a list of groups displayed by the “create recommendation” screen 230. A group of two or more users may be convenient if recommendations are frequently directed to a group of target users.

For example, a family may consist of a married couple, Alice and Bob, and their two children Carla and Dave. In this case, the “My Family” group in the group selection box 235 shown in FIG. 5 may represent the group of Alice, Bob, Carla and Dave. The “Kids” group in the group selection box 235 shown in FIG. 5 may represent the subset of Carla and Dave. As a result, Alice may select the “My Family” group to recommend media content for viewing by Alice, Bob, Carla and Dave or may select the “Kids” group to recommend media content for viewing by Carla and Dave. Selection of one or more groups in the user interface 200 may be performed instead of or in addition to selection of one or more individual users from the user selection box 231. For example, Alice may recommend “Bonholm's Folly” to be viewed by the “My Family” group and by an individual user “Eddie” using the same “create recommendation” screen 230.

In the specific example depicted in FIG. 5, the “X” in the box next to the “My Family” group may indicate that the recommending user navigated to the group selection box 235 and selected the “My Family” group. Further, the dotted line around a “Send Recommendation” control 240 provided by the user interface 200 may indicate that the recommending user has navigated to the “Send Recommendation” control 240. The recommendation 150 may be created and/or may be submitted in one of the previously discussed methods in response to activation of the “Send Recommendation” control 240. For example, the recommendation 150 may be stored for use by a media experience engine 29 which may be located in the same device which presents the user interface 200. As another example, the recommendation 150 may be conveyed by a message to a media experience engine 29 which may be remotely located and/or to the media experience support server 60.

The user interface 200 may have an “Edit Users” control 241 which may enable the recommending user to manage the list of users and/or the list of groups. For example, in response to activation and/or selection of the “Edit Users” control 241, the user interface 200 may display an additional screen (not shown) which may enable the recommending user to add users to be displayed in the user selection box 231, to remove users from the user selection box 231, to create users, to delete users, to create groups for the group selection box 235, to delete groups from the group selection box 231, to edit and/or to define which users are in a group, and/or the like.

The definitions of users and/or groups may be stored in a single media experience engine 29 and/or may be stored and managed centrally, such as, for example, in the media experience support server 60. Storing the definitions of users and/or groups in a single media experience engine 29 may be sufficient for a media experience engine 29 which services a small group, such as, for example, a family or an office network. Storing and managing the definitions of users and/or groups centrally may be appropriate for a distributed system which serves multiple media experience engines 29 and/or different viewing locations as previously set forth. In either case, the device presenting the user interface 200 may communicate with the media experience engine 29, the media experience support server 60 and/or another central device for managing the users and/or groups to obtain the list of users. Then, the list of users may be used to display the users and/or the groups. Further, the list of users may be used to edit and/or manage the users and/or the groups.

In an embodiment, the users may be defined centrally, and/or the groups may be defined on the media-capable devices. Therefore, a user with a personal media-capable device, such as, for example, a cell phone, a PDA and/or a laptop PC, may define the groups based on personal preferences. In this case, creation and/or generation of the recommendation 150 may require that the groups be expanded to list the users in each group. For example, the groups may be expanded to list the users in each group to enable the user to specify the one or more target users in the “List of Target Users” field 156 of the recommendation 150. Expansion of the groups may be performed automatically based on the group definitions known to the media-capable device which creates and/or generates the recommendation 150.

In another embodiment, both the users and the groups may be defined centrally. As a result, media-capable devices with recommendation capabilities may use a list of groups common to each of the media-capable devices. In this case, one or more target users in the “List of Target Users” field 156 of the recommendation 150 may include group names in addition to the names of users.

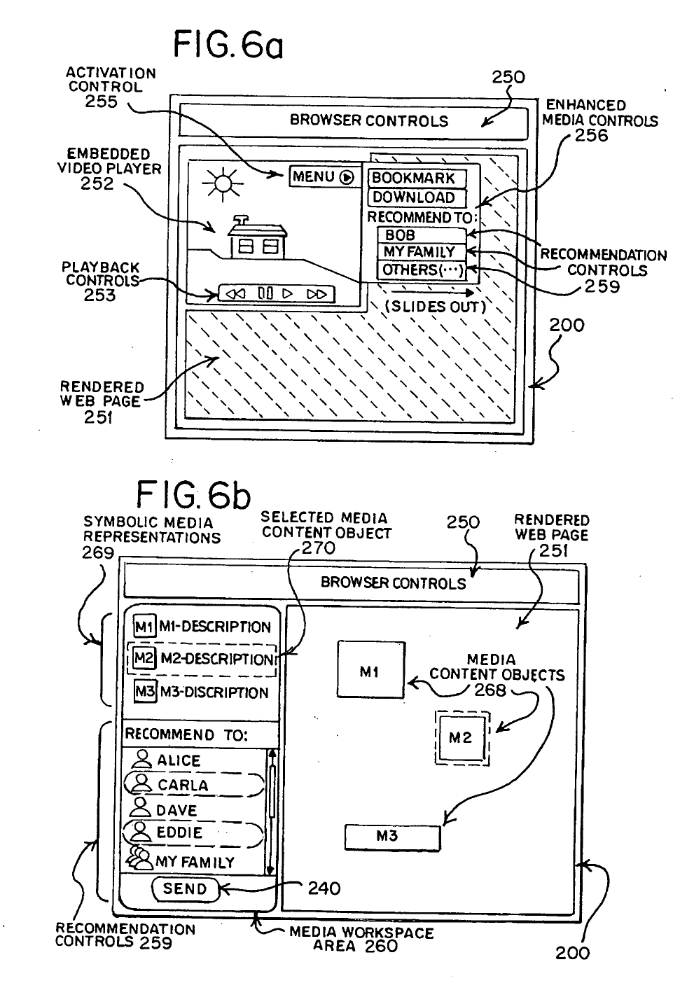

FIGS. 6a and 6b generally illustrate embodiments of the user interface 200 which may create, may generate and/or may submit recommendations 150 in a web browser. The user interface 200 may be provided as an integral component of a web browser or may be added to an existing web browser as a browser plug-in. A user interface 200 added to an existing web browser as a browser plug-in is referred to as a “recommendation plug-in” hereafter. Embodiments of the user interface 200 which use a web browser may enable the recommending user to create, generate and/or submit recommendations 150 based on media content encountered, identified, accessed and/or used in a web page.

FIG. 6a generally illustrates a web browser having browser elements, such as browser controls 250 and/or a rendered web page 251. The browser controls 250 may be and/or may have a URL entry box, a back button, a forward button, a refresh button, a home button, a button to access a list of bookmarked web pages and/or the like (not shown). The browser controls 250 may be and/or may have any controls for discovering, navigating and/or using web pages known to one skilled in the art, and the present invention is not limited to a specific embodiment of the browser controls 250.

The rendered web page 251 may display a rendering of web page content which may be text, graphic images, hyperlinks, embedded media objects and/or the like. As shown in the example depicted in FIG. 6a, the rendered web page 251 may display an embedded video player 252. The embedded video player 252 may have playback controls 253 which may enable the recommending user to render and/or control rendering of an associated video object. The embedded video player 252 may be implemented using a scripting language, such as, for example, Flash, Actionscript, Java, Javascript, ECMAScript and/or the like. The embedded video player 252 may use an installed video player and/or a browser plug-in. The present invention is not limited to a specific embodiment of the rendered web page 251 or the embedded video player 252.

The web browser and/or the recommendation plug-in may have the capability to recognize the presence of the embedded video player 252 and/or the presence of media content linked from and/or embedded in the rendered web page 251. Accordingly, the web browser and/or the recommendation plug-in may display an activation control 255 which may be associated with the embedded video player 252, a link to the media content, and/or the media content embedded in the rendered web page 251. The activation control 255 may be persistently displayed and/or may appear in response to use of and/or selection of the media content. For example, the activation control 255 may appear if the recommending user performs a “mouseover” action on the embedded video player 252, the link to the media content, and/or the media content embedded in the rendered web page 251.

The activation control 255 may enable the recommending user to access enhanced media controls 256 which may enable the web browser and/or the recommendation plug-in to provide enhanced functions not provided directly by the rendered web page 251. For example, the enhanced media controls 256 may be and/or may have controls to bookmark the media content, to download the media content to a local library, to organize the media content in a hierarchy of favorite media content, to redirect the media content to a rendering device, and/or to otherwise use the media content in ways not provided by the rendered web page 251. FIG. 6a depicts the enhanced media controls 256 “sliding out” of the embedded video player 252 when the activation control 255 is activated; however, various other display mechanisms and styles will be apparent to one skilled in the art.

The enhanced media controls 256 may have recommendation controls 259 which may enable the recommending user to recommend the media content to target users and/or groups. The recommendation controls 259 may have single click buttons to recommend the media content to specific target users associated with the buttons and/or predefined groups of users associated with the buttons. The recommendation controls 259 may have a control which may be activated and/or may be selected to obtain an additional screen for selecting users and/or groups. The additional screen may be similar in function to the “create recommendation” screen 230 depicted in FIG. 5. For example, a first button may be associated with a first target user, a second button may be associated with a second target user, a third button may be associated with a first target group, a fourth button may be associated with a second target group, and/or a fifth button may be activated and/or may be selected to obtain the additional screen. The recommendation controls 259 may have any number of controls or buttons, and the present invention is not limited to a specific embodiment of the recommendation controls 259.

The recommendation controls 259 may provide additional functions which may be used to edit and/or manage the list of users and/or groups. The additional functions may be used to customize which users and/or groups are displayed as single click buttons in the enhanced media controls 256. As a result, the recommendation controls 259 may enable the recommending user to utilize the web browser to create, generate and/or submit recommendations 150 based on media content discovered, identified, accessed and/or used in a web page.

FIG. 6b generally illustrates another embodiment of the user interface 200 which may create, may generate and/or may submit recommendations 150 in a web browser. The user interface 200 may be provided as an integral component of a web browser or may be added to an existing web browser as a browser plug-in. The web browser may have the browser elements, such as, for example, the browser controls 250 and/or the rendered web page 251.

The rendered web page 251 may have media content objects 268 which may be embedded in the rendered web page 251, may be displayed in an embedded media player (not shown), and/or may be linked from the rendered web page 251. The web browser and/or the recommendation plug-in may be capable of identifying the media content objects 268 of the rendered web page 251. Further, the web browser and/or the recommendation plug-in may present a media workspace area 260 to present the enhanced media controls 256 and/or the enhanced functions not provided by the rendered web page 251. As shown in FIG. 6b, the media workspace area 260 may be displayed to the left of the rendered web page 251; however, the media workspace area 260 may be displayed in other locations. For example, the media workspace area 260 may be displayed to the right of the rendered web page 251, above the rendered web page 251, and/or below the rendered web page 251. As another example, the media workspace area 260 may be displayed as “floating” on top of the rendered web page 251. The media workspace area 260 may be persistently displayed, may be displayed or hidden based on user input, may be displayed or hidden automatically based on the presence or the absence of the media content objects 268, and/or the like. The present invention is not limited to a specific embodiment by which the media workspace area 260 is displayed, and the media workspace area 260 may be displayed using any means known to one skilled in the art.

The media workspace area 260 may display symbolic representations 269 of the media content objects 268. The symbolic representations 269 may have and/or may be a graphic icon, an image, a text label, a text description, and/or other information which may identify the media content objects 268 corresponding to the symbolic representations 269. As an aid to identification, user input which selects and/or identifies one of the symbolic representations 269 may cause the one of the media content objects 268 corresponding to the one of the symbolic representations 269 to be selected and/or highlighted in the rendered web page 251. User input which selects and/or identifies one of the media content objects 268 in the rendered web page 251 may cause the one of the symbolic representations 269 corresponding to the one of the media content objects 268 to be highlighted in the media workspace area 260.

The media workspace area 260 may enable the recommending user to select, organize, manipulate and/or use the symbolic representations 269 in ways which may be unsuitable for the media content 268 as displayed in the rendered web page 251. For example, the media workspace area 260 may have controls (not shown) for selecting multiple symbolic representations 269, arranging two or more of the symbolic representations 269 into a presentation or a playlist, redirecting one or more of the symbolic representations 269 to a rendering device, and/or the like.

The media workspace area 260 may have the recommendation controls 259 to enable the recommending user to create, generate and/or submit a recommendation 150 based on one or more of the media content objects 268. The recommendation controls 259 may enable the recommending user to select and/or specify one or more users and/or groups for the recommendation 150. For example, the recommending user may select one or more of the symbolic representations 269 to specify one or more of the media content objects 268. Then, the recommending user may select one or more users and/or groups using the recommendation controls 259 to specify the one or more target users for the “List of Target Users” field 156 of the recommendation 150. To complete submission of the recommendation 150, the recommending user may activate the “Send Recommendation” control 240.

In the specific example depicted in FIG. 6b, the recommending user may have specified a selected symbolic representation 270 of the symbolic representations 269. The selected symbolic representation 270 may correspond to media content object M2, and user input specifying the selected symbolic representations 270 may cause the media content object M2 to be selected and/or highlighted in the rendered web page 251. Alternatively, the recommending user may have specified the media content object M2 in the rendered web page 251. User input specifying the media content object M2 may cause the one of the symbolic representations 269 corresponding to the media content object M2 to be selected and/or highlighted.

The recommending user may have selected two target users, namely Carla and Eddie, using the recommendation controls 259. At this point, the recommending user may activate the “Send Recommendation” control 240 to submit the recommendation 150. As a result, the recommendation 150 may be created by the web browser or the recommendation plug-in. Depending on the embodiment, the recommendation 150 may be delivered in a message to a media experience engine 29 and/or to a related component, such as, for example, the media experience support server 60.

The media workspace area 260 may enable other types of interaction for creating, generating and/or submitting the recommendation 150. For example, the media workspace area 260 may enable one or more of the symbolic media representations 269 to be “dragged and dropped” to a user and/or a group displayed in the recommendation controls 259. As another example, the media workspace area 260 may enable a representation of one of the media content objects 268 to be directly “dragged and dropped” from the rendered web page 251 to a user or group displayed in the recommendation controls 259. The media workspace area 260 may present other controls not shown in FIG. 6b. For example, the media workspace area 260 may present controls for configuring the recommendation process and/or for editing and/or managing the users and/or groups.

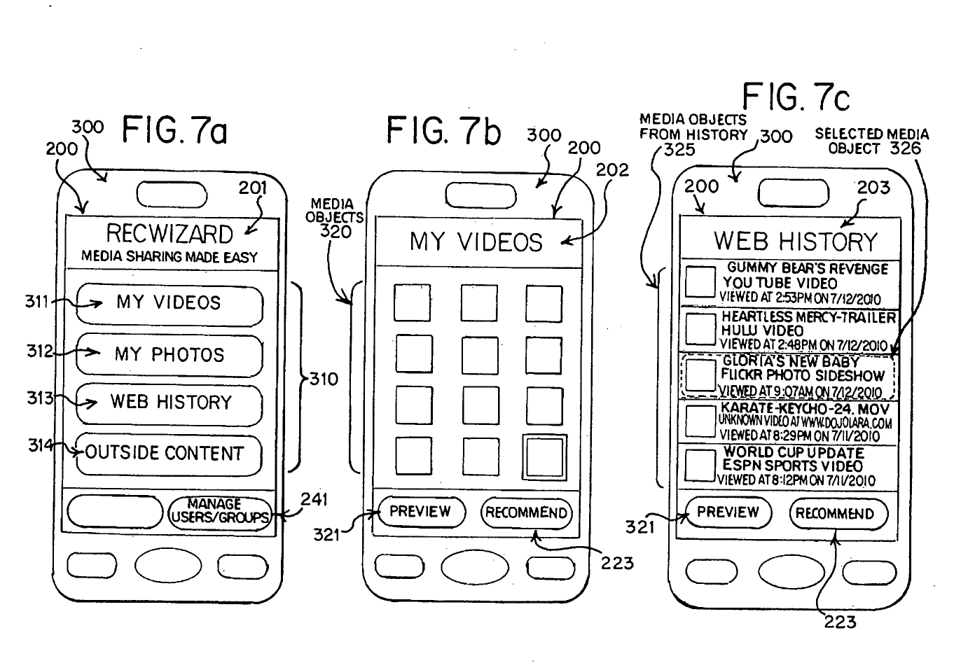

FIGS. 7a-7f generally illustrate embodiments of the user interface 200 for creating, generating, and/or submitting the recommendation 150. More specifically, FIGS. 7a-7f generally illustrate recommendation capabilities provided by a separate recommendation application which may be executed by a mobile device 300. The user interface 200 depicted in FIGS. 7a-7f may be designed for control by a touchscreen. For example, the touchscreen may display buttons which may be selected and/or may be activated by a finger press by the recommending user. The touchscreen may enable the recommending user to select objects, to check or uncheck check-boxes, to use finger swipes to scroll up and/or down a list of objects, to obtain a virtual keyboard for entering text into a text input box, and/or the like. These various input mechanisms are well known in the art, and the present invention is not limited to a specific input mechanism for the touchscreen.

FIG. 7a generally illustrates an initial selection screen 201 for the separate recommendation application. The initial selection screen 201 may provide content type controls 310 which may enable the recommending user to select the type of media content for the recommendation 150. The initial selection screen 201 may provide a first content type control 311, namely a “My Videos” button in the specific example depicted in FIG. 7a; a second content type control 312, namely a “My Photos” button in the specific example depicted in FIG. 7a; a third content type control 313, namely a “Web History” button in the specific example depicted in FIG. 7a; and/or a fourth content type control 314, namely an “Outside Content” button in the specific example depicted in FIG. 7a.

The “My Videos” button may enable the recommending user to select video content available on the mobile device 300 for use in the recommendation 150. For example, video files previously downloaded to, transferred to, or created by the mobile device 300 may be recommended using the “My Videos” button. The “My Photos” button may enable the recommending user to select digital photo content available on the mobile device 300 for use in the recommendation 150. For example, digital photos captured using a camera of the mobile device 300, digital photos previously downloaded to and/or transferred to the mobile device 300, and/or composite photo objects, such as slideshows or photo albums, may be recommended using the “My Photos” button.

The “Web History” button may enable the recommending user to recommend media content discovered, accessed, used or viewed using a web browser on the mobile device 300. Alternatively, the “Web History” button may enable the recommending user to recommend media content which has been bookmarked and/or marked as a “favorite” using the web browser on the mobile device 300. The separate recommendation application may communicate with the web browser to identify the media content to display using the “Web History” button. Alternatively, the separate recommendation application may access, read and/or parse a log file, a history file, a favorites file and/or another data file produced by the web browser on the mobile device 300 to identify the media content to display.

The “Outside Content” button may enable the recommending user to recommend external content, such as, for example, media content to which the mobile device 300 may not have direct access. Thus, the “Outside Content” button may provide a means for the recommending user to enter user input providing information known about the media content. In response, the separate recommendation application and/or the mobile device 300 may use the user input to search for and/or locate the media content for inclusion in the recommendation 150. If the separate recommendation application and/or the mobile device 300 searches for and/or locates the media content, the separate recommendation application and/or the mobile device 300 may confirm to the recommending user that the media content was found and/or may present a list of media content objects for disambiguation by the recommending user.

The separate recommendation application and/or the mobile device 300 may use the user input to generate the descriptive information for inclusion in the recommendation 150. If the separate recommendation application and/or the mobile device 300 generates the descriptive information for inclusion in the recommendation 150, the descriptive information may be conveyed to the media experience engine 29 and/or to the media experience support server 60. Then, the media experience engine 29 and/or to the media experience support server 60 may search for and/or locate the media content as previously set forth.

The initial selection screen 201 may provide additional controls, such as, for example, controls for configuration of the separate recommendation application, controls for managing and/or editing target users and/or groups, and/or controls for other functions not mentioned here. The present invention is not limited to the specific embodiment of the initial selection screen 201 depicted in FIG. 7a.

FIG. 7b generally illustrates an embodiment of a media object selection screen 202. For example, the recommending user may navigate to the media object selection screen 202 by activating the “My Videos” button and/or the “My Photos” button in the initial selection screen 201. FIG. 7b depicts an embodiment of the media object selection screen 202 activated the “My Videos” button. However, a similar embodiment of the media object selection screen 202 may enable selection of photos, photo albums, audio files and/or other media content types, such as, for example, articles or e-books.

The media object selection screen 202 may display available media content objects 320 and/or may enable the recommending user to navigate through and/or select from the available media content objects 320. For example, user input may specify a selected media content object 322 of the media content objects 320. The media object selection screen 202 may provide a “Preview” control 321 which may enable the recommending user to preview one of the available media content objects 320, such as, for example, the selected media content object 322. For example, in response to selection of the “Preview” control 321, the mobile device 300 may play a video, display a digital photo, provide a photo album viewer application, and/or the like. As a result, the recommending user may explore the available videos, photographs, photo albums and/or other media content objects using the media object selection screen 202.

After selecting one or more of the media content objects 320, the recommending user may use the “recommend” control 223 to proceed to a user selection screen 209 described in more detail hereafter to complete and/or submit the recommendation 150. For example, after specifying the selected media content object 322, the recommending user may use the “recommend” control 223 to proceed to the user selection screen 209 to complete and/or submit a recommendation 150 having the selected media content object 322 as the recommended media content.

FIG. 7c generally illustrates an embodiment of a web history selection screen 203. The recommending user may navigate to this screen by activating the “Web History” button in the initial selection screen 201. The web history selection screen 203 may display one or more media content objects 325 from a web history (hereafter “the web history media content objects 325”). The web history media content objects 325 may have been recently discovered, accessed, used and/or viewed using the web browser of the mobile device 300 and/or may have been bookmarked and/or marked as a “favorite” using the web browser. As shown in FIG. 7c, the web history media content objects 325 may be displayed in a list which may be scrolled. Each of the web history media content objects 325 which may be displayed may have a graphic representation and/or a text description. The graphic representation may be, for example, a thumbnail photo, an icon and/or another visual representation of the one of the web history media content objects 325. The text description may have and/or may be, for example, a title; a content type; a content source; a date and/or time when the one of the web history media content objects 325 was discovered, accessed, used or viewed; and/or the like. The present invention is not limited to a specific embodiment of the graphic representation or the text description.

The recommending user may select one or more of the web history media content objects 325 from the web history media content objects 325 which may be displayed by the web history selection screen 203. For example, user input may specify a selected web history media content object 326 of the web history media content objects 325. As previously set forth, the recommending user may preview one or more media content objects, such as, for example, the selected web history media content object 326, using the “Preview” control 321. After selecting one or more of the web history media content objects 325, the recommending user may use the “recommend” control 223 to proceed to the user selection screen 209 described in more detail hereafter to complete and submit the recommendation. For example, after specifying the selected web history media content object 326, the recommending user may use the “recommend” control 223 to proceed to the user selection screen 209 to complete and/or submit a recommendation 150 having the selected web history media content object 326 as the recommended media content.

FIG. 7d generally illustrates an embodiment of an external content type selection screen 204. The recommending user may navigate to the external content type selection screen 204 by activating the “Outside Content” button in the initial selection screen 201. The external content type selection screen 204 may be used to specify the type of outside content, and, therefore, may provide context for the user input which may be requested by one or more subsequent screens. In FIG. 7d, the external content type selection screen 204 may provide a first content type button 331, namely a “Movie” button in the specific example depicted in FIG. 7d; a second content type button 332, namely a “TV Program” button in the specific example depicted in FIG. 7d; a third content type button 333, namely a “Music Video” button in the specific example depicted in FIG. 7d; a fourth content type button 334, namely a “Song/Album” button in the specific example depicted in FIG. 7d; and/or a fifth content type button 335, namely an “Other” button in the specific example depicted in FIG. 7d. The “Other” button may enable the recommending user to view an expanded list of content types and/or may enable the recommending user to enter free-form search text without constraining context.

FIG. 7e generally illustrates an embodiment of a TV Program specification screen 205 which may be used to provide information about external television programming content. The recommending user may navigate to the TV Program specification screen 205 by activating the “TV Program” button in the external content type selection screen 204. The TV Program specification screen 205 may present user input fields in which the recommending user may provide information about a TV Program. One or more of the user input fields may be text input boxes for which a virtual keyboard and/or physical keyboard may be used to enter text. Alternatively, one or more of the user input fields may use and/or may be check-boxes, a drop-down selection list, radio buttons which enable the recommending user to select only one of a predefined set of options, a slider control which enables the recommending user to adjust values in a finite range along at least one axis, and/or other user input mechanisms. For example, a “Title” field 341 may be a text input box and/or a “Network” field 343 may be a drop-down selection list. The present invention is not limited to a specific user input mechanism for the TV Program specification screen 205, and the user input mechanism for the TV Program specification screen 205 may be any user input mechanism known to one skilled in the art.

The recommending user may enter user input in one or more of the “Title” field 341, an “Actor/Host” field 342, the “Network” field 343, a “Provider/Channel” field 344, and/or an “Air Date and Time” field 345. As a result, the recommending user may enter information available about the external media content. The separate recommendation application, the mobile device 300, the media experience engine 29 and/or the media experience support server 60 may use the information provided by the recommending user to search for, identify and/or locate a version of the external media content.

In the example shown in FIG. 7e, the recommending user may have entered a provider and/or a channel in the “Provider/Channel” field 344, and/or an air date and time in the “Air Date and Time” field 345. For example, the recommending user may have seen a television program on a public screen in an airport or in a restaurant and/or may have discovered a television program while watching television at a friend's house. The recommending user may not know the title of the television program but may know other information, such as, for example, the provider, namely “TriTech Cable” in the example depicted in FIG. 7e; the channel, namely “Channel 6” in the example depicted in FIG. 7e; and/or the date and the time the TV program aired, namely “Wednesday the 7th of July, 2:00 PM” in the example depicted in FIG. 7e.

The separate recommendation application may provide user input mechanisms for entering the information. For example, the separate recommendation application may provide a drop-down list of service providers which service the current geographical area of the mobile device 300 and may enable the recommending user to select the provider from the drop-down list. As another example, the separate recommendation application may pre-populate the “Air Date and Time” field 345 with the current date and time to cover the situation where the recommending user is recommending a live program currently being watched. As a result, the user input required to provide the information for the TV Program specification screen 205 may be minimized. After providing user input which specifies information for the external television programming content, the recommending user may activate a “Done” control 350 to proceed to the user selection screen 209 to complete submission of the recommendation 150.

FIG. 7e generally illustrates an embodiment of the TV Program specification screen 205, and similar specification screens may be provided for the other external content types referenced in the external content type selection screen 204. For example, a movie specification screen (not shown) may request movie information, such as, for example, a title, an actor/actress, a director, a film genre, and/or the like. Further, a specification screen for music videos, songs and/or albums (not shown) may request information, such as, for example, a title, an artist name, a band name, a musical genre, a lyric sample, a music label, a release year, and/or the like. A music specification screen may request a radio station, an air date and/or an air time to specify when the song was heard on a radio. The information fields listed herein are examples, and other information fields may be used as appropriate to the content type. The present invention is not limited to specific information fields.

FIG. 7f generally illustrates an embodiment of the user selection screen 209. The recommending user may navigate to the user selection screen 209 after selecting media content for the recommendation 150 using the media object selection screen 202, the web history selection screen 203, the external content type selection screen 204, the TV Program specification screen 205, and/or a specification screen for another external content type. The user selection screen 209 may provide user selection controls 351 which may have a list of one or more users and/or groups. The user selection controls may be used by the recommending user to specify the one or more target users for the “List of Target Users” field 156 of the recommendation 150. As shown in the example depicted in FIG. 7f, a list of available users and groups may be provided. The recommending user may scroll up and/or scroll down through the list and/or may specify one or more selected users and/or groups. After specifying the one or more selected users and/or groups 352, the recommending user may activate a “Done” control 355 to complete submission of the recommendation 150. As a result, the separate recommendation application may create, generate and/or submit the recommendation 150, and/or the recommendation 150 may have the one or more selected users and/or groups 352 as the target users. The recommendation 150 may be stored and/or may be sent in a message to a media experience engine 29 and/or a related component, such as, for example, a media experience support server 60.

In an embodiment, the initial selection screen 201 and/or the user selection screen 209 may have additional controls. For example, a “Manage Users/Groups” control 241 may enable the recommending user to create, define, hide, reveal and/or edit the users and/or the groups which may appear in the user selection screen 209.

One skilled in the art will recognize that the user interface 200 may provide the structure and function disclosed herein while using modifications to the design of the embodiments of the user interface 200 depicted in FIGS. 7a-7f. For example, the mobile device 300 may accept user input using soft keys, buttons, a directional control pad, a trackball and/or a joystick. As another example, the separate recommendation application may be provided by a non-mobile computing device which may have a larger screen than a typical mobile device and/or may have other user input mechanisms, such as, for example, a keyboard, a mouse, a remote control, a game controller and/or the like.

The embodiments of the user interface 200 generally illustrated in FIGS. 7a-7f may have applicability in addition to the separate recommendation application. For example, a mobile device file browser and/or other media discovery tool may have the “recommend” control 223. Activation of the “recommend” control 223 for a media content object selected in the mobile device file browser and/or other media discovery tool may result in display of the user selection screen 209 and/or may enable the recommending user to complete and/or submit the recommendation 150. As a result, the mobile device file browser and/or the other media discovery tool may have recommendation capabilities.

The examples generally illustrated in FIGS. 5, 6a, 6b and 7a-7f demonstrate that recommendation capabilities may be provided across a range of media-capable devices using a combination of specially designed or extended media discovery tools, plug-ins to media discovery tools, and/or separate media recommendation applications. As a result, a common framework for recommending media content may be extended across the numerous media-capable devices, media discovery tools, and/or media content sources which may be available to the recommending users of one or multiple media experience engines 29. Such tools need not be developed or deployed simultaneously to enable functionality of the media experience engine 29. Instead, the tools may be updated, distributed and/or deployed over time to gradually build and improve the recommendation capabilities available to the various recommending users.

Creation of the media experience sessions, including the organization and tracking of the media recommendations by the media experience engine 29, is discussed in more detail hereafter. One or more of the viewing users 30 may interact with a media experience engine 29 to request that a media experience session be generated and/or displayed on a media rendering device 31. The request may specify the viewing users 31 and/or the time duration for the media experience session.

The request may specify other parameters for the media experience session, such as, for example, a preferred type of content; a list of one or more recommending users for whom the list indicates a preference for media content recommended by one or more recommending users; a list of one or more of the viewing users 30 for whom the list indicates a preference for media content recommended to be viewed by the one or more viewing users 30; a preference for recently recommended media content; a preference for media content from older recommendations; and/or the like. The preferred type of media content may be a media type, such as, for example, audio, video and/or photo. The preferred type of media content may be a content genre, such as, for example, comedy, drama, news, sports, musical theater, country music, rock and roll, opera and/or the like. The preferred type of media content may indicate a typical content length, such as, for example, short video clips, thirty minute shows, sixty minute shows, long form movie content, and/or the like. The preferred type of media content may indicate a preference for locally stored media content; for user-generated media content; for media content created, generated, and/or edited by one or more specified users; for content tagged as relevant to one or more specified users; and/or for media content from a specific content source. The specific content source may be, for example, a cable TV provider, a video on demand service, an online video sharing site, a music service, a photo sharing website, and/or the like. The request for the media experience session may specify a media experience session template as described in further detail hereafter.

As a result, the media experience engine 29 may organize, create, and/or generate a media experience session appropriate for the viewing users 30 and/or in accordance with the other information communicated in the request. The organization, creation and/or generation of the media experience session may be based on the recommendations 150 previously created, generated and/or submitted by recommending users.

The media experience engine 29 may have previously received and/or stored the recommendations 150. Alternatively, the media experience engine 29 may request, may obtain and/or may receive the recommendations 150 in response to the request for the media experience session by the viewing users 30. For example, the media experience engine 29 may communicate with the media experience support server 60 to request the recommendations 150 relevant to the request. The recommendations 150 relevant to the request may be the recommendations 150 having target users in the “List of Target Users” field 156 which are viewing users 30.

The media experience session may have media content specified in the recommendations 150. As previously set forth, the media experience engine 29 and/or a related component, such as, for example, the media experience support server 60, may process the recommendations 150 to obtain, discover, identify, locate and/or retrieve the media content. Such processing may be performed in advance of receipt of the request from the viewing users 30, and/or the processing may be performed in response to the request from the viewing users 30. The media content may be sent to and/or may be rendered by the media rendering device 31 in the media experience session.

The media experience session may have additional media content not specified in the recommendations 150. For example, the media experience session may have advertisements, featured media content, current news, upcoming events, live broadcasts, content matching the preferences of one or more of the viewing users 30, and/or the like. In an embodiment, at least a portion of the additional media content may be inserted according to the requirements of a service provider. In an embodiment, at least a portion of the additional media content may be configurable by a user through the user interface provided by the media experience engine 29 and/or a related component. In an embodiment, at least a portion of the additional media content may be specified by the viewing users 30 when creating and/or editing a template as described in further hereafter. In an embodiment, at least a portion of the additional media content may be relevant to an anniversary date, an activity and/or a scheduled event associated with and/or relevant to one or more of the viewing users 30.

The viewing users 30 may view the media experience session. For example, the viewing users 30 may view the media experience session in a single location on an available rendering device, such as the media rendering device 31. As another example, the viewing users 30 may view the media experience session on multiple rendering devices in multiple locations. For example, the viewing users 30 may have two sub-groups in two different locations connected by a network. The two sub-groups may be in communication with one or more media experience engines 29 to request, receive, control and/or view a common media experience session on two separate media rendering devices. For example, the media experience session may be viewed simultaneously on the two separate media rendering devices, or the media experience session may be viewed at different times on the two separate media rendering devices. The present invention is not limited to a specific number of the viewing users 30 or a specific number of sub-groups of the viewing users 30, and any number of the viewing users 30 or sub-groups of the viewing users 30 may request, receive or view the media experience session.

The media experience engine 29 may record tracking information regarding whether specific users of the viewing users 30 view the media content of the recommendation 150. The media experience engine 29 may use the tracking information to organize the media experience sessions. For example, the tracking information may be used to ensure that each of the recommendations 150 is resolved by the media content being viewed by each of the target users in the “List of Target Users” field 156 of the recommendation 150. As another example, the tracking information may be used to select appropriate media content for the viewing users 30 based on unresolved recommendations associated with the viewing users 30.

The media experience engine 29 may record tracking information for partial resolution and/or full resolution of the recommendations 150. For example, if a recommendation 150 recommends first media content to Alice, Bob, and Carla, the recommendation 150 may be partially resolved if Alice and Bob view the first media content in a media experience session. At a later time, the recommendation 150 may be considered fully resolved if Carla views the first media content. If the recommendation 150 is fully resolved, the media experience engine 29 may remove the recommendation 150 from further consideration and/or use in creating media experience sessions.

The resolution of the recommendation 150 may be based on multiple media experience sessions which may occur at different physical locations and/or may involve multiple media experience engines 29. For example, the media experience support server 60 may determine the partial resolution and/or the full resolution of a recommendation 150 targeting a first viewing user and/or a second viewing user. The first viewing user may view the media content in a first location in a media experience session generated by a first media experience engine 29a in a first local network. As a result, the first media experience engine 29a may communicate with the media experience support server 60 to partially resolve the recommendation 150.

Later, the second viewing user may view the content in a second location in a media experience session generated by a second media experience engine 29b in a second local network. As a result, the second media experience engine 29b may communicate with the media experience support server 60 to indicate that the second viewing user viewed the content. Then, the media experience support server 60 may adjust the tracking information to indicate full resolution of the recommendation 150. For example, the media experience support server 60 may create and/or modify a record which indicates that the recommendation 150 is fully resolved and/or is not to be used to generate subsequent media experience sessions.

Equivalently, the recommendation 150 may be segmented into a first sub-recommendation that the first viewing user view the media content and a second sub-recommendation that the second viewing user view the media content. In this case, the viewing of the media content by the first viewing user in the first location may resolve the first sub-recommendation, and the viewing of the media content by the second viewing user in the second location may resolve the second sub-recommendation. The full resolution of the recommendation 150 may be achieved based on resolution of all sub-recommendations associated with the recommendation 150. In this way, an embodiment may use the concept of sub-recommendations to track the recommendation 150 to full resolution as the target users may view the recommended content in one or multiple media experience sessions.

The media experience engine 29, the media experience support server 60 and/or another related component may create, may store and/or may maintain a history of recommendations 150 which were resolved. The media experience engine 29 may use the history to reduce and/or to avoid repeat viewings of the same media content by a viewing user. For example, the media experience engine 29 may receive a first recommendation 150 which recommends a first media content object for a first viewing user. Then, the media experience engine 29 may use the history to discover that the first viewing user recently viewed the first media content object in accordance with a second recommendation 150 which was resolved before receipt of the first content recommendation 150. As a result, the media experience engine 29 may decline to offer the first media content object to the first viewing user because the first viewing user recently viewed the first media content object. Further, the media experience engine 29 may create and/or may modify a record which indicates that the first content recommendation is partially resolved and/or fully resolved. Still further, the media experience engine 29 may create and/or modify a record which indicates that the first recommendation 150 is not to be used to generate subsequent media experience sessions for the first viewing user.

Accordingly, the media experience engine 29, the media experience support server 60, and/or another related component may maintain a database of recommendations 150 and/or records describing the partial resolution and/or the full resolution of each of the recommendations 150. As a result, the media experience engine 29 may determine the recommendations 150 and/or the target users referenced by the recommendations 150 which are relevant for creation of a media experience session.

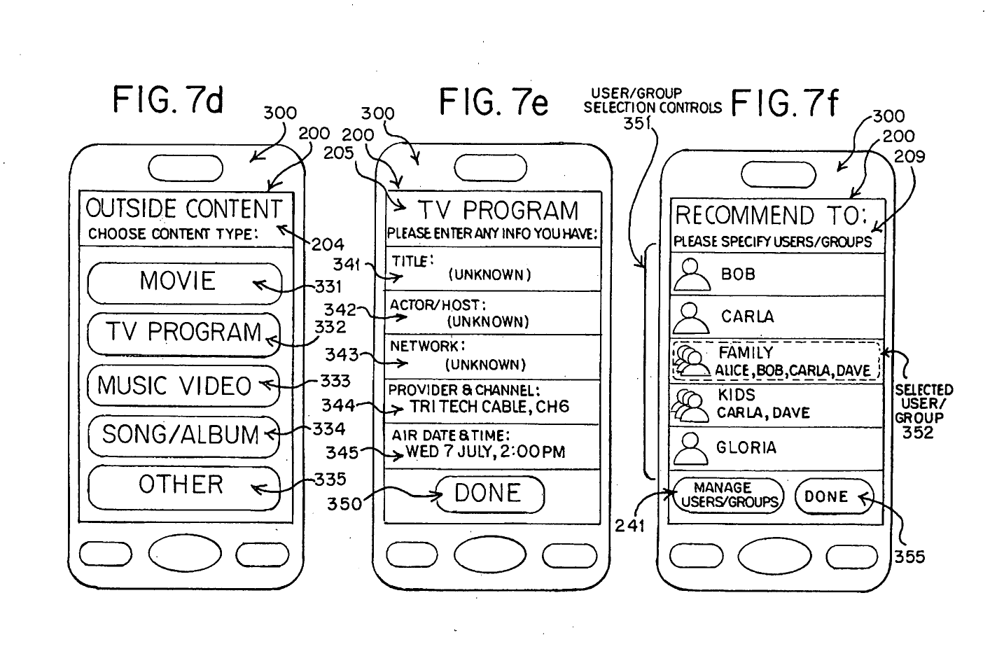

FIG. 8 generally illustrates a method 400 for creating and/or presenting a media experience session in an embodiment of the present invention. At step 401, the media experience engine 29 may receive a request to generate a media experience session. The request may specify the viewing users 30. In an embodiment, the request may specify a duration of the media experience session, a recommending user, a first viewing user, and/or a template. In response to receipt of the request, at step 403, the media experience engine 29 may access a database of recommendations 150 which specify a recommending user, media content, and/or one or more target users. Then, at step 405, the media experience engine 29 may select a first set of recommendations 150 from the database of recommendations 150. Each of the recommendations 150 in the first set of recommendations 150 may specify a target user who is one of the viewing users 30. In an embodiment, one or more of the recommendations 150 in the first set may specify the media content using a URL. In an embodiment, one or more of the recommendations 150 in the first set may specify the media content using a description which does not specify a location from which the content may be accessed.

Then, at step 407, the media experience engine 29 may generate a media experience session which may arrange media content on a timeline. The media experience session may have the media content specified by the first set of recommendations 150. If the request specifies the duration of the media experience session, the media experience engine 29 may generate the media experience session based on the duration. If the request specifies a recommending user, the media experience engine 29 may generate the media experience session based on the recommendations 150 from the first set submitted by the recommending user. If the request specifies a first viewing user, the media experience engine 29 may generate the media experience session based on the recommendations 150 from the first set which specify the first viewing user as one of the target users. If the request specifies a template, the media experience engine 29 may generate the media experience session based on the template as described in more detail hereafter.

Then, in step 409, the viewing users 30 may view the media experience session. The media experience engine 29 may record the tracking information which specifies which viewing users viewed the media content during the media experience session. Further, for each of the recommendations 150, the media experience engine 29 may use the tracking information to determine which target users specified by the recommendation 150 viewed the media content associated with the recommendation 150. The media experience engine 29 may partially or fully resolve the recommendations accordingly.

The media experience engine 29 may generate the media experience session based on a template. The template is discussed in more detail hereafter. The template may be provided by a service provider, may be created by a user, may be edited by one or more users in the viewing users 30, may be generated by the media experience engine 29 according to content preferences of one or more users in the viewing users 30, and/or the like. The present invention is not limited to a specific source of the template or a specific method by which the template is created.

The template may specify how the media content may be arranged on a timeline to produce a media experience session. The template may specify one or more time intervals for presenting, displaying and/or viewing media content of various types. For each of the time intervals, the template may have a time specification and/or a content specification.

In an embodiment, the time specification for a time interval may be an amount of time. For example, a template may have a first time interval of “two minutes,” a second time interval of “five minutes,” and/or a third time interval of “twelve minutes and thirty seconds.” The time specifications may specify any amount of time.

In an embodiment, the time specification for a time interval may be a fraction of the duration of the media experience session. For example, a template may have time intervals corresponding to “⅙,” “⅓,” and/or “½” of the duration of the media experience session. Further, the template may have time intervals which correspond to percentages of the duration of the media experience session. The media experience engine 29 may scale the template to the duration provided in the request for the media experience session.

In an embodiment, the time specification for a time interval may specify a minimum amount of time and/or a maximum amount of time. For example, a template may specify that a time interval is at least six minutes and is no more than twelve minutes. As another example, a template may specify that a time interval is at least twenty-five percent of the duration of the media experience session and no more than forty percent of the duration of the media experience session.

In an embodiment, the time specification for a time interval may specify a starting time, an ending time, a starting date, an ending date and/or a recurrence pattern. For example, a template may be created for the time period from 7:00 pm to 9:00 pm every Friday. The time intervals for the template may have time specifications which provide a starting time and/or an ending time. For example, a first time interval may be specified to start at 7:00 pm and/or end at 7:25 pm every Friday. As a result, the viewing users 30 may establish in advance a scheduled media experience session with an absolute time and/or a regularly recurring media experience session with known recurrence times.

In an embodiment, the template may combine time specifications of the various types previously set forth. For example, the template may specify a first time interval of five minutes, a second time interval of one-half of the session duration, and/or a third time interval between twelve minutes and fifteen minutes.

The media experience engine 29 may identify media content for display in the time interval based on the time specification and/or the content specification associated with the time interval. The media experience engine 29 may not require an exact match to the time specification. The duration of the media content may be made to approximately match the time specification by adding the durations of one or more available media content objects which match the content specification.

For example, the template may have a first time interval with a time specification of “five minutes” and/or a content specification which instructs the media experience engine 29 to display media content recommended by a first recommending user. The media experience engine 29 may access the recommendations 150 to identify three recommendations 150 submitted by the first recommending user which are relevant to the viewing users 30. The three recommendations 150 may respectively specify three media content objects as follows: a first media content object with a duration of four minutes and two seconds (4:02), a second media content object with a duration of thirty-seven seconds (0:37), and a third content object with a duration of twenty-four minutes (24:00).

The media experience engine 29 may determine that the first media content object and the second media content object may be displayed in sequence to approximately match the “five minute” time specification of the first time interval. Therefore, the media experience engine 29 may select the first media content object and the second media content object for display in the first time interval of the media experience session. The media experience engine 29 may not select the third media content object because selection of the third media content object results in a mismatch between the time specification for the first time interval and the total duration of the media content selected for and/or presented in the first time interval. More generally, the media experience engine 29 may use the possible combinations of the available media content objects which match the content specification of a time interval to select the combination which most closely matches the time specification of the time interval.

The content specification for a time interval'may have one or more media types, one or more descriptive media parameters, one or more recommendation qualifiers, and/or other parameters which may be used to select media content for presenting, displaying and/or viewing in the time interval. The media types may be, for example, audio, video and/or image. The descriptive media parameters may be, for example, a genre, a style, a topic, a sport, a hobby, an activity, an event, an artist, an actor, an actress, a director, a musical style, a music label, a content provider, a content source, a content storage location, a requirement that media content be user-generated, a requirement that media content be locally stored, and/or the like. The recommendation qualifiers may be a list of one or more recommending users to indicate that the time interval displays media content recommended by the one or more recommending users, a list of one or more target users to indicate that the time interval displays media content recommended to be viewed by the one or more target users, a preference for media content recommended recently, a preference for media content recommended not recently, a preference for media content recommended during a range of dates and/or times, a preference for media content from previously resolved recommendations 150, and/or the like.

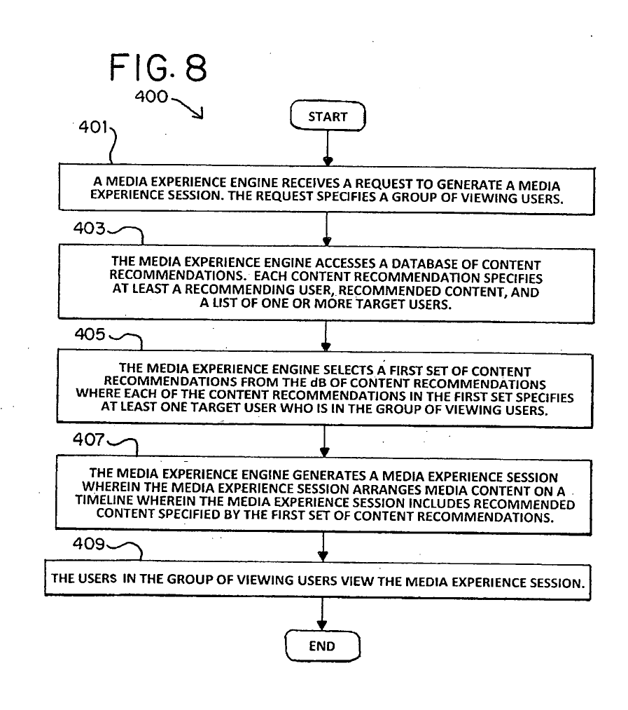

FIG. 9a generally illustrates an embodiment of the template 410. As shown in FIG. 9a, the template 410 may have four time intervals arranged on a timeline. Each time interval may have a time specification and/or a content specification. The template 410 may have any number of time intervals, and the present invention is not limited to a specific number of time intervals of the template 410. Several examples based on FIG. 9 are presented hereafter to generally illustrate specific templates which may be generated, may be created and/or may be used in embodiments of the present invention.

As a first example, an embodiment of the template 410 may be created and/or may be provided by a service provider as generally illustrated in FIG. 9b. For example, a provider of a media experience session service may create the template 410. As shown in FIG. 9b, the template 410 may have time intervals 409, time specifications 411 associated with the time intervals 409, and/or content specifications 412 associated with the time intervals 409. The template 410 may specify a fixed total duration, such as, for example, one hour, which may include featured media content, such as, for example, media content selected by the service provider; advertisements which may provide financial support for the service; media content referenced by a recommendation 150 which targets the viewing users 30; and/or a local photo slideshow based on an anniversary date. The content specifications 412 of the time intervals 409 and techniques for selecting media content for display according to the content specifications 412 are described in further detail hereafter.

The third time interval and the seventh time interval of the template 410 in the first example may have content specifications 412 which may require the media content recommended for one or more of the viewing users 30. Therefore, the media experience engine 29 may process available recommendations 150 to identify, select and/or access the media content recommended for viewing by one or more of the viewing users 30. Further, the media experience engine 29 may select and/or may arrange the media content for display in the third time interval and the seventh time interval. Selection of the media content to fill one or more of the time intervals 409 is described in further detail hereafter.

As a second example, an embodiment of the template 410 created and/or edited by a user of the media experience engine 29 is generally illustrated in FIG. 9c. For example, the template 410 may be created by Alice to establish a media experience session associated with a live television broadcast show which her family regularly watches on Tuesdays from 8:00 pm to 8:30 pm. Thus, the template 410 may represent a recurring scheduled media experience session in which Alice's family, namely parents Alice and Bob and their children Carla and Dave, participates on Tuesday evenings.

In an embodiment, the media experience engine 29 may make adjustments based on the recommendations 150, the amount of available media content which matches the content specification 412 for each of the time intervals 409, and/or the available users of the viewing users 30. On a typical Tuesday night, the viewing users 30 may be Alice, Bob, Carla and Dave. Accordingly, the media experience engine 29 may attempt to fill the first time interval, namely the time period from 7:30 pm to 7:45 pm, using media content recommended by Alice to be viewed by one or more of the four family members. The media experience engine 29 may adjust the time specification 411 of the first time interval; for example, the media experience engine 29 may end the first time interval before 7:45 pm if less than fifteen minutes of suitable media content is available to fill the first time interval. Alternatively, the media experience engine 29 may fill the first time interval by displaying additional media content which does not match the content specification 412 of the first time interval.

In an embodiment, the media experience engine 29 may avoid adjusting the time boundaries of a live broadcast program. For example, the media experience engine 29 may avoid adjusting the time boundaries of the third time interval to maintain the real-time “live” viewing of the live TV broadcast.

In another embodiment, the media experience engine 29 may adjust the time boundaries because of a delay in the start of viewing of the media experience session and/or an interruption in the viewing of the media experience session. For example, the media experience engine 29 may maintain the time specification 411 for the live TV broadcast, namely the third time interval, while adjusting, delaying or moving the time specifications for the other time intervals 409 which do not represent live broadcasts. As another example, the media experience engine 29 may have a DVR function and/or may communicate with a DVR-capable device to time delay the live TV broadcast in accordance with the delay and/or the interruption of the viewing of the media experience session.

As a third example, an embodiment of the template 410 generated by a media experience engine 29 based on a requested session duration and/or a number of viewing users (hereafter “N”) is generally illustrated in FIG. 9d. The media experience engine 29 may generate the template 410 to have N+2 time intervals 409. The first time interval may display a five minute presentation which may include a service introduction and/or a news and weather report as indicated in FIG. 9c. The service introduction may introduce and/or promote a service provider; for example, the service introduction may promote the provider of a media experience session service. The news and weather report displayed in the first interval may be provided by a service provider which may be the provider of the media experience session service or a different provider.

The first time interval may followed by N time intervals 409 which may each have a duration of zero to fifteen minutes, and/or each of the N time intervals 409 may display media content recommended by one or more of the viewing users 30. As previously set forth, the media experience engine 29 may select media content suitable for display in each of the N time intervals 409 by processing recommendations 150 previously submitted by the one or more of the viewing users 30. If relevant media content is unavailable for display in one of the N time intervals 409, then the media experience engine 29 may effectively display zero minutes of media content as allowed by the time specification 411 of the corresponding time interval 409. If more than fifteen minutes of relevant media content is available for display in one of the N time intervals 409, then the media experience engine 29 may select the media content from the available relevant media content to match the fifteen minute maximum of the time specification 411 as closely as possible.

The template 410 of the third example may have an (N+2)nd time interval in which the media experience engine 29 may display additional media content relevant to the viewing users 30. The type of media content displayed in the (N+2)nd time interval may depend on the embodiment of the media experience engine 29 and/or the relevant available media content. For example, the media experience engine 29 may display in the (N+2)nd time interval one or more of the following media content types: media content selected based on content preferences pre-configured by one or more of the viewing users 30; media content selected based on a media viewing history of one or more of the viewing users 30; user-generated media content created, generated and/or edited by one or more of the viewing users 30; media content relevant to an anniversary date of one or more of the viewing users 30; media content relevant to a recent event and/or activity of one or more of the viewing users 30; media content relevant to an upcoming scheduled event and/or activity of one or more of the viewing users 30; and/or the like.

The user-generated media content may be, for example, digital photographs, digital video files, camcorder footage, recorded audio files, recorded music, blog entries, social network postings, and/or the like. The user-generated media content may be selected by the media experience engine 29 based on a creation date, a posting date, and/or a date of last editing. The user-generated media content may be selected by the media experience engine 29 based on available local media content. For example, the media experience engine 29 may examine digital photographs, digital video files and/or other user-generated content types stored in the local network to select user-generated content for display in the (N+2)nd time interval.

As another example, the user-generated content may be selected by the media experience engine 29 based on access to and/or examination of a web site and/or a sharing service on which the media content may have been posted. For example, the media experience engine 29 may have access to a photo sharing website, a video sharing website, a blogging site, and/or the like to identify, select and/or access the user-generated content. Further, the media experience engine 29 may have access to specific account information, such as, for example, a username, a password, an access credential and/or the like. The account information may correspond to one or more viewing users and/or one or more, recommending users identified by the media experience engine 29. Therefore, the media experience engine 29 may use the account information to access the user-generated media content on a web site, a sharing service, and/or another entity which stores the user-generated media content.

The present invention is not limited to these examples, and the media experience engine 29 may identify, may access and/or may select the user-generated media content for display using any available source of user-generated media content.

The media content relevant to an anniversary date may be media content relevant to a birthday, a wedding anniversary, an engagement date, a date on which a relationship and/or a friendship began, a moving date, a graduation date, a baptism date and/or another date associated with and/or relevant to one or more of the viewing users. For example, the media experience session may create, may generate and/or may present a slideshow of wedding photographs in a media experience session viewed by a married couple on an anniversary of their wedding. As another example, the media experience session may create, may generate and/or may present a highlight video of a college graduation ceremony of a graduating one of the viewing users 30. The highlight video may be displayed with scenic pictures of the university from which the graduating user graduated in a media experience session viewed by the graduating user on an anniversary of the graduation. As a result, the media experience session may assist the viewing users 30 to remember and/or to celebrate the anniversaries of important dates in the lives of the viewing users 30.

Alternatively, the media content relevant to the anniversary date may be user-generated media content created, submitted, posted and/or edited on a date a predefined number of years before the date of the viewing of the media experience session. For example, the media experience session may generate a random slideshow based on digital photographs taken a predefined number of years before the viewing of the media experience session. The digital photographs may be stored in a local network, may be accessible on an external photo sharing site, and/or the like. The digital photographs may have tags identifying one or more of the viewing users 30 and/or may be linked to a photo sharing account of one or more of the viewing users 30. The media experience session may display an introduction to the slideshow, such as, for example “What were we doing on this day 7 years ago?” As a result, the media experience engine 29 may assist the viewing users 30 in revisiting activities from the past in a useful and structured way.

The media content relevant to an event and/or an activity may be media content relevant to a sporting event, a camping trip, a vacation trip, a dinner party, a family reunion, a business trip, a hobby, a theater production, a musical concert, and/or the like. The activity may involve exercise; for example, the media content may be an exercise video, and/or the viewing users 30 may exercise while the exercise video is shown during the media experience session. The event and/or the activity may be a past event, a recent event, an event planned and/or scheduled for a future date, and/or the like. As a first example, the media experience engine 29 may display highlight clips from the 2008 Major League Baseball All-Star Game based on a determination that one or more of the viewing users 30 is a baseball fan, based on a determination that one or more of the viewing users 30 attended the 2008 Major League Baseball All-Star Game, and/or based on a determination that one or more of the viewing users 30 previously viewed at least a portion of the 2008 Major League Baseball All-Star Game.

As a second example, the media experience engine 29 may display video footage of the Tahitian islands based on identification of an upcoming family vacation trip to Tahiti. As a third example, the media experience engine 29 may display music videos and/or video footage from recent concerts for a rock band based on a determination that one or more of the viewing users 30 purchased tickets to an upcoming concert to be performed by the rock band.

The media content relevant to an event and/or an activity may be user-generated media content and/or may be media content from an external content source. For example, the media experience engine 29 and/or a related component may search for media content in one or more available content sources. The media experience engine 29 and/or the related component may identify media content related to the event and/or the activity which may be examined, may be selected and/or may be arranged for display in a time interval 409. The media content may be provided by a service provider. For example, the service provider may be a travel service associated with the media experience engine 29 which may provide standard video introductions to popular vacation destinations. As another example, the service provider may be a music label may provide promotional videos related to music artists who perform concert tours.

The media experience engine 29 may have access to a scheduling database for one or more of the viewing users 30. For example, the media experience engine 29 may have access to a calendar program, a meeting planning program and/or another source of past events and/or future events scheduled for the viewing user. The media experience engine 29 may access the scheduling database to determine activities and/or events which may be relevant to the viewing users. As a result, the media experience engine 29 may identify, may access, may arrange and/or may present media content based on the activities and/or the events.

Alternatively or additionally, the user interface of the media experience engine 29 may enable the viewing users 30 to schedule events, to identify relevant activities and/or to identify significant dates, such as, for example, birthdays and anniversaries. The user interface may enable the viewing users to enter a date, a title and/or another description for the event, the activity and/or the significant date. The user interface may have standard categories selectable by the viewing users, such as, for example, “birthday,” “anniversary,” “vacation trip,” “business trip,” “sporting event,” “concert” and/or the like. The standard categories may enable the viewing users 30 to provide information about the events, the activities and/or the significant dates to assist the media experience engine 29 in identification of relevant media content. The user interface may enable the viewing users 300 to specify one or more of a content location, a content source, a content tag and/or another content identifier to further assist the media experience engine 29 in identification of relevant media content. As a result, the media experience engine 29 may discover, may access, may arrange and/or may present media content based on the event, the activities, and/or the significant dates.

As set forth in the preceding examples, the media experience engine 29 and/or another component, such as the media experience support server 60, may select media content recommended to be viewed by one or more of the viewing users 30 based on processing of available recommendations 150. For example, the media experience engine 29 and/or another component, such as the media experience support server 60, may process available recommendations 150 which target one or more of the viewing users 30 for which the media experience session is generated. The media content may be selected for display in a time interval 409 which may be specified by a template 410.

The media experience engine 29 may have default rules and/or algorithms to select media content from relevant media content objects if the relevant media content objects are too voluminous to display in a specified time interval 409. As a first example, the media experience engine 29 may order the recommendations 150 by submission date and/or may process the recommendations 150 in the order in which the recommendations 150 were submitted. Until the available time interval 409 is filled with media content, the media experience engine 29 may select media content recommended for viewing by one or more of the viewing users 30 and/or which is in accordance with the content specification 411 for the time interval 409.

As a second example, the media experience engine 29 may have an algorithm which may consider possible combinations of the media content objects relevant to a time interval 409 to most closely match the duration of a combination of the media content objects to the time specification 411 of the time interval 409. As a third example, the media experience engine 29 may have an algorithm which may alternately select for display the media content recommended to be viewed by each of the viewing users 30. For example, the viewing users 30 may be a first viewing user, a second viewing user and a third viewing user. The media experience engine 29 may select media content to fill a time interval 409 by selecting a first media content object recommended to be viewed by the first viewing user, a second media content object recommended to be viewed by the second viewing user, and a third media content object recommended to be viewed by the third viewing user. This pattern may be repeated with additional media content objects while attempting to most closely match the total duration of the first media content object, the second media content object and the third media content object to the time specification 411 of the time interval 409.

As a fourth example, the media experience engine 29 may have an algorithm which may select media content for display to maximize resolution and/or completion of the relevant recommendations 150. For example, the media experience engine 29 may obtain a first set of recommendations 150. Each of the first set of recommendations 150 may target one or more users in the viewing users 30 and/or may recommend media content in accordance with the content specification 412 for the time interval 409. Then, the media experience engine 29 may consider the possible combinations of media content objects which are referenced by the recommendations 150 in the first set. The media experience engine 29 may select the combination of media content objects which enables the maximum number of recommendations 150 from the first set to be resolved and/or partially resolved while having a total display time sufficiently close to the time specification 411 for the time interval 409. Total display time may be the total time required to sequentially display the combination of media content objects in the time interval 409 including any introductions, transitions, user markup and/or other ancillary media content which may be displayed with the media content objects.

For example, in an embodiment, the media experience engine 29 may consider all possible combinations of the media content objects of the recommendations 150 in the first set which have a total display time within ten percent of the time specification 411 for the time interval 409. Therefore, for a specific time interval 409 with a time specification of “five minutes,” the media experience engine 29 may consider all possible combinations of media content objects which have a total display time of at least four minutes and thirty seconds (4:30) and not more than five minutes and thirty seconds (5:30). The media experience engine 29 may select the combination of media content objects which maximizes a content recommendation resolution metric. Examples of content recommendation resolution metric are provided hereafter.

As a first example, a first content recommendation resolution metric may be the number of recommendations 150 which may be fully resolved as a result of displaying the combination of media content objects to the viewing users 30. Therefore, the media experience engine 29 may select the combination of media content objects which maximizes the number of recommendations 150 fully resolved by displaying the combination of media objects to the viewing users 30.

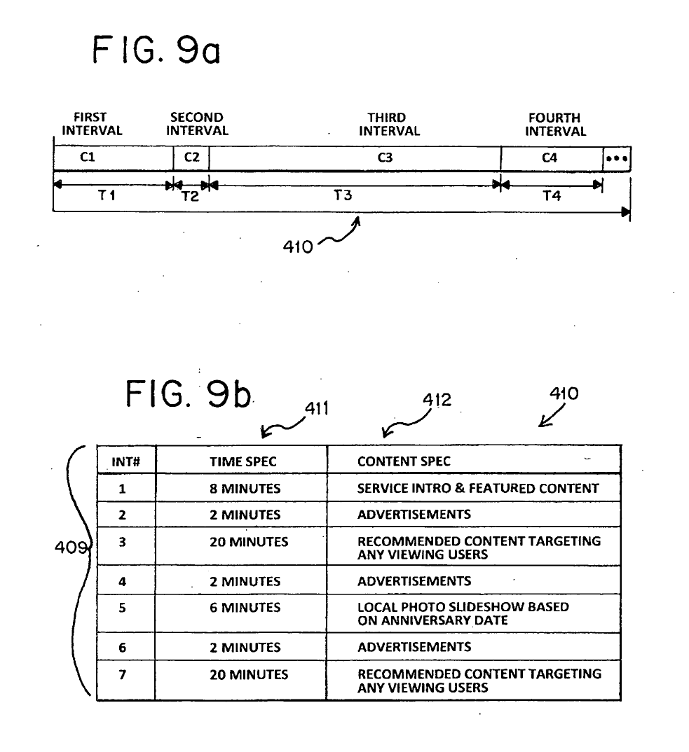

As a second example generally illustrated in FIG. 10, each of the recommendations 150 having recommended content objects 431 and/or a list of target users 432 may be partitioned into an equivalent set of one or more atomic recommendations 430 which recommend a single media content object to a single target user. The recommending user 433 of the recommendation 150 may be considered as the recommending user of each of the atomic recommendations 430. A second content recommendation resolution metric may be the number of atomic recommendations 430 which may be resolved by displaying the combination of media content objects to the viewing users 30. Therefore, the media experience engine 29 may select the combination of media content objects which maximizes the number of atomic recommendations 430 which may be fully resolved by displaying the combination of media content objects to the viewing users 30.

As a third example, each of the recommendations 150 may be partitioned into the equivalent set of atomic recommendations 430, and each of the atomic recommendations 430 may be weighted by the display time of the media content object recommended by the atomic recommendation 430. Then, a third content recommendation resolution metric may be the summation of display time weights compiled for the atomic recommendations 430 which may be resolved by displaying the combination of media content objects to the viewing users 30. Therefore, the media experience engine 29 may select the combination of media content objects which maximizes the summation of display time weights compiled for the atomic recommendations 150 which may be resolved by displaying the combination of media content objects to the viewing users 30.

The present invention is not limited to the techniques of the preceding examples. The present invention is not limited to a specific method for selecting media content objects for display in the time interval 409 in accordance with a set of recommendations 150. Any technique for selecting media content objects known to one skilled in the art may be used in the present invention.

Further, the preceding examples are described using techniques for selecting media content objects or display in a time interval 409 with an associated time specification 411 and/or an associated content specification 412. However, one skilled in the art will recognize that some or all of the preceding examples may be applicable for selecting media content objects if the time interval is “open” in that the time interval presents no restrictions on time, no restrictions on content selection, or no restrictions on time or content selection. For example, the various techniques presented in the preceding examples may be used to select media content objects for display in a time interval 409 which lacks a content specification. If a time interval 409 lacks a content specification, media content recommended to be viewed by one or more of the viewing users 30 may be considered relevant for display without consideration of a content specification 412. The various techniques of the preceding examples may be used to select media content objects in the absence of a template 410 because the absence of a template 410 may be equivalent to a single time interval 409 which lacks a content specification 412.

The media experience engine 29 may have rules and/or algorithms to select additional media content objects for display in a time interval 409 for which media content objects are not available to match a content specification 412 of the time interval 409. For example, the media experience engine 29 may recommend additional media content objects based on predetermined content preferences and/or a media content viewing history of the viewing users 30. As another example, the media experience engine 29 may apply a content specification 412 less stringently to expand the number of matching media content objects. For example, if insufficient local news content is available to fill a time interval 409 for which the content specification 412 requires local news content, the content specification 412 may be applied less stringently to allow more general news content to fill the time interval 409. As another example, if an insufficient number of clips no longer than twenty seconds are available to fill a time interval 409 for which the content specification 412 requires content in clips no longer than twenty seconds, the content specification 412 may be applied less stringently to include clips which are up to thirty seconds long.

In an embodiment, the media experience engine 29 may adjust one or more of the time specifications 411 based on availability and/or unavailability of media content objects which match the corresponding content specifications 412. For example, the media experience engine 29 may determine that insufficient media content is available for display in a first time interval with a first content specification. The media experience engine 29 may determine an excess of media content objects are available for display in a second time interval with a second content specification. As a result, the media experience engine 29 may decrease the time specification of the first time interval by a time amount and/or may increase the time specification of the second time interval by the same time amount. Accordingly, the media experience engine 29 may fill the first time interval and the second time interval while preserving the overall duration of the media experience session.

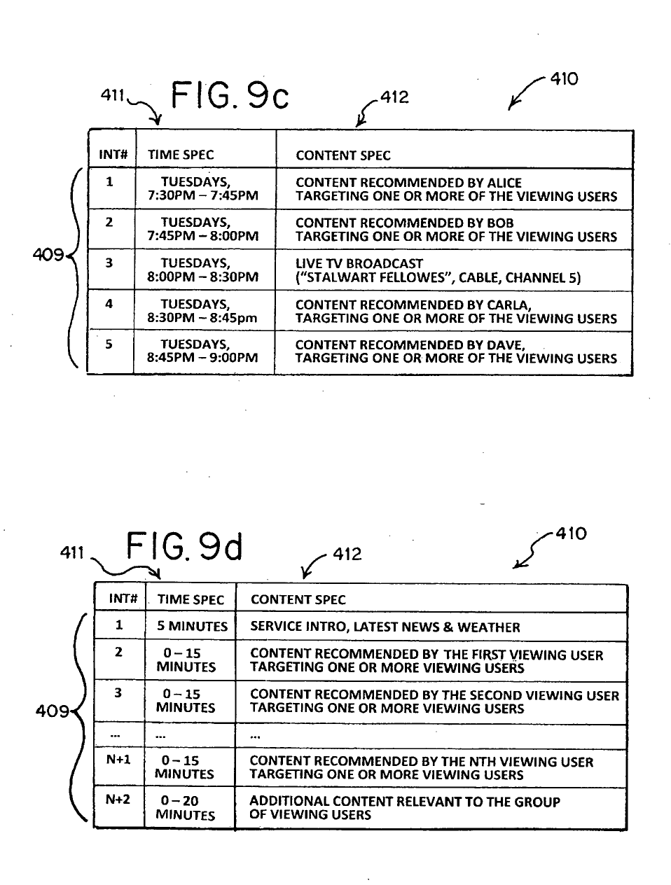

Examples of recommendations 150 used in generation of media experience sessions follow hereafter. The examples are based on parents Alice and Bob, their children Carla and Dave, and family friends Eddie, Freddy and Gloria. For each of the recommendations, FIG. 11 generally illustrates the information provided by the2 “Recommending User” field 152, the “Recommended Content” field 154, the “List of Target Users” field 156, and the one or more “User Markup” fields 160. As a result of the actions in the following examples, the recommendations 150 summarized in FIG. 11 may be generated and/or may be submitted to a media experience session service, to one or more media experience engines 29, and/or to one or more other components, such as, for example, the media experience support server 60.

For a first recommendation 150a, Alice may be driving to work when she hears on the radio that the movie “Caves of Zambia” was released on DVD and through some Video-on-Demand services. When Alice arrives at work, she may use the separate recommendation application on her smartphone to select the “Outside Content” button in the initial selection screen 201 displayed by the user interface 200 of the smartphone. Then, she may select the “Movie” button in the external content type selection screen 204 displayed by the user interface 200. In response to selection of the “Movie” button, the user interface 200 may display a movie specification screen which may enable her to enter information about a movie to recommend. She may enter the title, namely “Caves of Zambia.” Then, the user interface 200 may display the user selection screen 209 to enable her to select the “Family” group and the “DONE” control 352 to generate the first recommendation 150a. As a result, the separate recommendation application may generate the first recommendation 150a using the fields specified in FIG. 11. More specifically, the first recommendation 150a may have the “Recommending User” field 152 set to “Alice,” the “Recommended Content” field 154 specifying a content description comprising “Type=Movie” and “Title=Caves of Zambia,” and the “List of Target Users Field” 156 specifying Alice, Bob, Carla and Dave as the target users.

The media experience engine 29 which provides service to Alice's family may receive and/or may process the first recommendation 150a. In response to processing the first recommendation 150a, the media experience engine 29 may access available content sources in an attempt to locate and/or obtain the movie “Caves of Zambia” for presentation to Alice's family as a stand-alone viewing session or within one or more media experience sessions. Based on communication with the available content sources, the media experience engine 29 may determine that the movie is not available from any free internet sources and is not listed in the two-week program listing available from the cable provider of the family.

However, the media experience engine 29 may locate the movie “Caves of Zambia” in a “pay-for-play” video streaming service for which Bob has an account. Depending on the embodiment, the media experience engine 29 may be authorized to purchase video streams through the pay-for-play service, and/or the media experience engine 29 may communicate with Alice, Bob or one of the other viewing users to authorize the purchase. For example, the media experience engine 29 may send an email request to Bob which may indicate that Alice recommended “Caves of Zambia” to be viewed by the family. The email may request that Bob authorize the media experience engine 29 to purchase the video stream for inclusion in a future media experience session. As another example, the media experience engine 29 may request authorization at initiation of a media experience session in which at least a portion of the movie “Caves of Zambia” is involved.

For a second recommendation 150b, Alice may be searching for new TV programs in the interactive program guide provided by her cable set-top box which may have recommendation capabilities. She may find a new TV series, namely “Middle School Musical,” which she thinks the children would enjoy. She may access the detail information screen 210 for the new TV series in the user interface 200 of the set-top box. She may select the “recommend” control 223 to proceed to the “create recommendation” screen 230. She may use the user selection box 231 of the “create recommendation” screen 230 to select her children, namely Carla and Dave, from the list of target users. Then, she may select the “send recommendation” control 240 to submit the second recommendation 150b.

As a result, the cable set-top box may generate the second recommendation 150b using the fields specified in FIG. 11. In particular, the “Recommended Content Field” 154 of the second recommendation 150b may specify a content description comprising various sub-fields which may include “Type=TV Show,” “Series Name=Middle School Musical”, “Channel=39”, “Air Date=2 November 2010”, “Air Time=8:00 pm”, and “Duration=30 minutes.”

For a third recommendation 150c, Bob may be browsing the internet at lunchtime on his office PC. He may find a first video clip on a video sharing site, namely www.MewTube.com. The video clip is entitled “Cat playing the Cello,” and Bob thinks the video clip would be enjoyable to his son Dave and to Dave's friends Eddie and Freddy. Bob may use the recommendation capabilities of a browser plug-in to recommend the first video clip to Dave, Eddie and Freddy. For example, Bob may use the recommendation controls 259 and/or the “Send Recommendation” control 240 of the browser plug-in to recommend the first video clip to Dave, Eddie and Freddy.

As a result, the browser plug-in may generate the third recommendation 150c using the fields specified in FIG. 11. In particular, the browser plug-in may generate the “Recommended Content Field” 154 of the third recommendation 150c to include a direct link to the video content, namely the HTTP URL http://www.mewtube.com/c12zpy9.flv as noted in FIG. 11.

For a fourth recommendation 150d, Bob may find a second video clip on the video sharing site during the same internet browsing session. The second video clip is entitled “Kitty playing the Sitar.” Bob may use the recommendation capabilities of the browser plug-in to recommend the second video clip to Dave, Eddie and Freddy. For the fourth recommendation 150d, Bob may enter a text introduction as enabled by the browser plug-in having the recommendation capabilities. Bob may enter the text introduction “Watch closely, doesn't this look like Aunt Helga's cat?” when submitting the fourth recommendation 150d using the browser plug-in. As a result, the browser plug-in may generate the fourth recommendation 150d using the fields specified in FIG. 11 and/or the text introduction entered by Bob in the one or more “User Markup” fields 160.

For a fifth recommendation 150e, Bob may be browsing an online news website during his coffee break later that afternoon. He may view a third video clip entitled “Rally at the State Capitol” which he would like to view again at home with his wife Alice. Using the recommendation capabilities of his browser plug-in, Bob may recommend the third video clip to be viewed by Bob and Alice. Further, Bob may indicate to the browser plug-in the additional requirement that the third video clip be viewed by the target users together. For example, the browser plug-in may have an additional control to create the additional requirement for the fifth recommendation 150e. As a result, the browser plug-in may generate the fifth recommendation 150e using the fields specified in FIG. 11 and/or the additional requirement that the target users Alice and Bob view the recommended content together.

For a sixth recommendation 150f, Carla may be at home and may want her family to see the photos from her recent school field trip to an art museum. She may create and/or may edit a slideshow using photo editing software on a laptop PC. She may use recommendation capabilities of the laptop PC to recommend the slideshow to Alice, Bob, Carla, and Dave. The recommendation capabilities may enable her to record a voice introduction to the media content using a microphone associated with the laptop PC. She may record the voice introduction, and then submit the recommendation. As a result, the software which provides the recommendation capabilities on the laptop PC may generate the sixth recommendation 150f using the fields specified in FIG. 11. In particular, the “Recommended Content” field 154 may specify the photo slideshow as an attached content object having the filename “museum-trip.mp4.” Accordingly, the photo slideshow may be attached to the message which conveys the sixth recommendation 150f. Further, the one or more “User Markup” fields 160 may specify the recorded voice introduction. For example, the one or more “User Markup” fields 160 may specify the recorded voice introduction as an attached audio file having the filename “museum-intro.mp3,” and the audio file may be attached to the message which conveys the sixth recommendation 150f.

For a seventh recommendation 150g, Carla may be at the mall where she may see two prom dresses in a store window. She may use the camcorder function of her smartphone to record a video clip of walk-around views of each of the dresses while she speaks comments about features she likes about each dress. She intends the comments for her own memory and for discussion with her mother Alice. Then, Carla may use the recommendation capabilities of the camcorder application on the smartphone to recommend the recorded video clip to be viewed by Alice and Carla together. In addition, Carla may use the recommendation capabilities of the camcorder application on the smartphone to add the requirement that the recorded video clip be viewed exclusively by Alice and Carla so that the recorded video clip is not shown to users other than Alice and Carla.

As a result, the camcorder application may generate the seventh recommendation 150g using the fields specified in FIG. 11. In particular, the “Recommended Content” field 154 may specify the recorded video clip as an attached content object having the filename “video101003_{—}04.3gp.” Accordingly, the recorded video clip may be attached to the message which conveys the seventh recommendation 150g. Further, the “List of Target Users” field 156 may specify Alice and Carla as the target users and/or may convey the requirements that target users Alice and Carla view the recorded video clip together and that target users Alice and Carla be the exclusive viewers of the recorded video clip.

For an eighth recommendation 150h, Carla may hear about a new Justin Casey music video called “Forever” while having lunch with a friend. She may identify a link to the music video in the mobile browser of her smartphone, and she may use the recommendation capabilities of the mobile browser to recommend viewing of the music video to herself, namely Carla. As a result, the mobile browser which provides the recommendation capabilities may generate the eighth recommendation 150h using the fields specified in FIG. 11. In particular, the “Recommending User” field 152 and the “List of Target Users” field 156 may respectively specify that Carla is both the recommending user and the sole target user. Further, the “Recommended Content” field 154 may specify a direct link to the music video, namely the HTTP URL http://www.jcofficial/forever-video.flv. In this way, Carla may create a recommendation to herself to view the music video at a later time, and a media experience engine 29 may later act on this recommendation by including the music video in a media experience session in which Carla is a target user.

For a ninth recommendation 150i, Dave may be at home watching a Megamech cartoon episode on the family's cable set-top box. He may use the recommendation capabilities of the set-top box to recommend the episode he watched, namely “Death Match,” to his friends Eddie and Freddy. Eddie and Freddy are not family members; however, they may be users of the same media experience session service as Dave's family. Alternatively, they may be users of a compatible media experience session service which is in communication with the media experience session service used by Dave's family, or they may have access to a media experience engine 29 capable of receiving recommendations 150 generated by the set-top box used by Dave and his family.

As a result, the set-top box may generate the ninth recommendation 150i using the fields specified in FIG. 11. In particular, the “Recommended Content” field 154 may specify a content description comprising various sub-fields which may include “Type=TV Show,” “Series Name=Megamech,” “Episode Name=Death Match,” “Season=4,” “Episode=7,” and/or “Network=CTUNE.” The ninth recommendation 150i may be delivered to, may be received by and/or may be accessible to a media experience engine 29. Then, the media experience engine 29 may process the ninth recommendation 150i when creating a media experience session for which Eddie and/or Freddy are target users. The media experience engine 29 may search for, may locate, may retrieve and/or may obtain the Megamech cartoon episode based on the content description. Thus, the media experience engine 29 may include the Megamech cartoon episode in the media experience session for which Eddie and/or Freddy are target users.

For a tenth recommendation 150j, Eddie may be in chemistry class and may notice that the chemistry teacher Mr. Beaks is wearing his shirt inside out. While Mr. Beaks is writing on the chalkboard, Eddie may use the camera function of his smartphone to take a picture of Mr. Beaks. After class, Eddie may use the recommendation capabilities of his smartphone to recommend the single photo to Dave, Eddie and Freddy. When creating the tenth recommendation 150j, Eddie may use a “voice overlay” feature to record voice comments to be played while the photo is viewed in a media experience session. For example, Eddie may record the voice comments using the microphone of his smartphone.

As a result, the software which provides the recommendation capabilities for Eddie's smartphone may generate the tenth recommendation 150j using the fields specified in FIG. 11. Specifically, the “Recommended Content” field 154 may specify the single photo as an attached content object having the filename “10101400798a.jpg,” and the file containing the single photo may be attached to the message which conveys the tenth recommendation 150j. Further, the one or more “User Markup” fields 160 may specify the voice comments recorded by Eddie. For example, the one or more “User Markup” fields 160 may specify the recorded voice comments as an attached audio file having the filename “20101012-001.amr,” and the audio file may be attached to the message which conveys the tenth recommendation 150j.

For an eleventh recommendation 150k, Freddy may be browsing a music website on the web browser of his smartphone. He may find a new music video called “Endless” by Justin Casey. Freddy may remember that Dave's sister Carla is a Justin Casey fan. Therefore, Freddy may use the recommendation capabilities of the web browser to recommend the music video for viewing by Carla. As a result, the web browser and/or the browser plug-in which provides recommendation capabilities for the web browser may generate the eleventh recommendation 150k using the fields specified in FIG. 11.

For a twelfth recommendation 150l, Alice's friend Gloria may have recently taken a vacation to the Galapagos Islands. Using a tablet device, she may use photos and video footage of the vacation to create a twenty minute video presentation which she names “Galapagos Island Hop.” She may use the recommendation capabilities of the video editing software on the tablet device to recommend the video presentation for viewing by Alice and Bob. The video editing software and/or the tablet device may upload the video presentation to an associated video sharing service which may generate a URL for inclusion in the twelfth recommendation 150l. As a result, the video editing software which provides the recommendation capabilities may generate the twelfth recommendation 150l using the fields specified in FIG. 11. Specifically, the “Recommended Content Field” 154 may specify the video presentation using a direct link, namely the HTTP URL generated by the video sharing service, http://www.sharex.com/gwu-807.mov. Then, the HTTP URL may be used by a media experience engine 29 and/or a related component to request, access, and/or retrieve the video from the video sharing service for inclusion in a media experience session for which Alice and/or Bob are target users.

Examples follow of a media experience engine 29 creating media experience sessions at the request of the viewing users 30 using the example recommendations 150 summarized in FIG. 11. As a first example of creation of a media experience session, Alice, Bob, Carla and Dave finish dinner at home on Thursday, Oct. 28, 2010. Then, they gather on the couch for a family TV viewing session. Bob may access the user interface of the media experience engine 29 on the living room television using an infrared remote control. For example, the media experience engine 29 may be provided by the living room television and/or a set-top box which may provide cable television service and/or a DVR function.

Bob may select an option which requests a media experience session for immediate viewing. Bob may specify the available viewing users, namely Alice, Bob, Carla, and Dave, and/or may specify the desired session duration, such as, for example, forty-five minutes. Bob may not specify any additional structure for the media experience session. For example, Bob may not specify a media experience session template 410.

The media experience engine 29 may process the available recommendations 150, such as, for example, the recommendations 150a-150l summarized in FIG. 11. The media experience engine 29 may identify media content relevant for inclusion in the requested media experience session. For example, the media experience engine 29 may identify media content which is recommended to be viewed by one or more of the viewing users 30, namely Alice, Bob, Carla and Dave. Such media content may be identified as relevant for inclusion in the requested media experience session.

The media experience engine 29 may consider other factors when determining relevancy of the media content. For example, the media experience engine 29 may consider only media content which is currently available to and/or accessible to the media experience engine 29. As another example, the media experience engine 29 may remove recommended media content from consideration if the associated recommendation 150 was previously resolved with respect to the target users. As yet another example, the media experience engine 29 may consider additional requirements specified in the recommendation 150, such as a requirement that recommended media content be viewed together by one or more target users, a requirement that recommended media content be viewed exclusively by one or more target users, a requirement that recommended media content not be viewed by certain target users, and/or the like. As another example, the media experience engine 29 may consider other parameters for the media experience session, such as a preferred type of content; a list of one or more recommending users for whom the list indicates a preference for media content recommended by one or more recommending users, a list of one or more of the viewing users 30 for whom the list indicates a preference for media content recommended to be viewed by the one or more viewing users 30, a preference for recently recommended media content, a preference for media content from older recommendations, and/or the like. The other parameters for the media experience session may be specified in the request for the media experience session and/or may be associated with one or more of the target users.

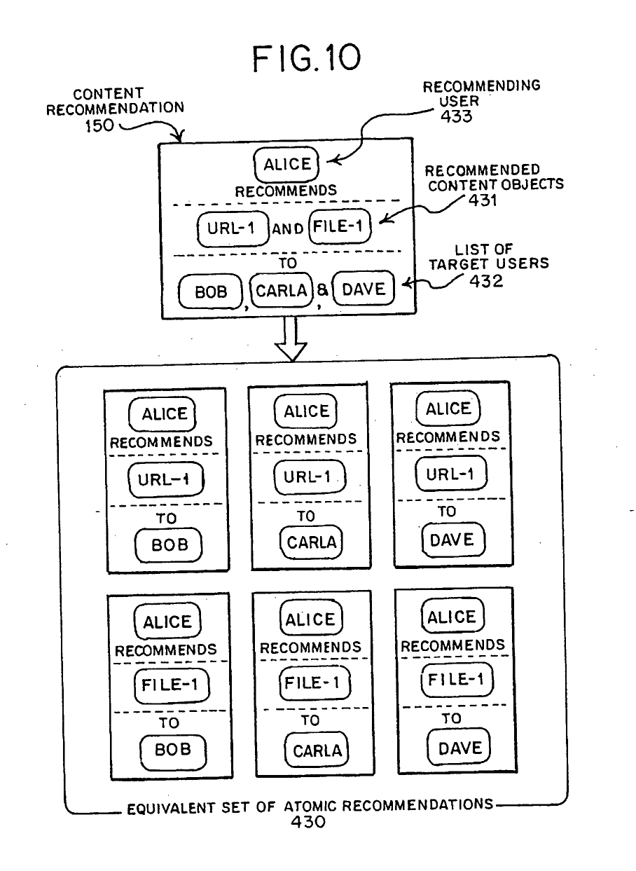

FIG. 12 generally illustrates how the media experience engine 29 may determine relevancy of the media content objects from the recommendations 150a-150j. The table presented in FIG. 12 corresponds to the current example of Bob requesting a media experience session for immediate viewing by target users Alice, Bob, Carla and Dave after dinner on Thursday, Oct. 28, 2010. The third column of the table indicates whether each of the media content objects corresponding to recommendations 150a-150j is considered by the media experience engine 29 to be relevant for inclusion in the media experience session requested by Bob. The fourth column of the table provides an explanation for each of the relevancy determinations.

The media experience engine 29 may select some or all of the relevant media content objects for display in the media experience session. For example, the media experience engine 29 may consider combinations of the relevant media content objects to determine the combination having a total duration which most closely matches the requested session duration, namely forty-five minutes. As another example, the media experience engine 29 may select relevant media content objects for the media experience session based on maximizing the number of recommendations 150 and/or the number of atomic recommendations 430 which may be resolved by viewing the media experience session. The media experience engine 29 may select relevant media content objects in other ways, such as, for example, by using any of the various means of selecting media content objects for a time interval 409 previously set forth.

The media experience engine 29 may select the relevant media content objects and/or may present the media experience session for viewing by the viewing users 30 on the living room television. Alternatively, the media experience engine 29 may present options for two or more possible media experience sessions based on the recommendations 150 and/or the relevant media content objects. For example, the media experience engine 29 may present a first option to view the first forty-five minutes of the movie “Caves of Zambia” and a second option to view a forty-five minute collection of shorter clips selected by the media experience engine 29.

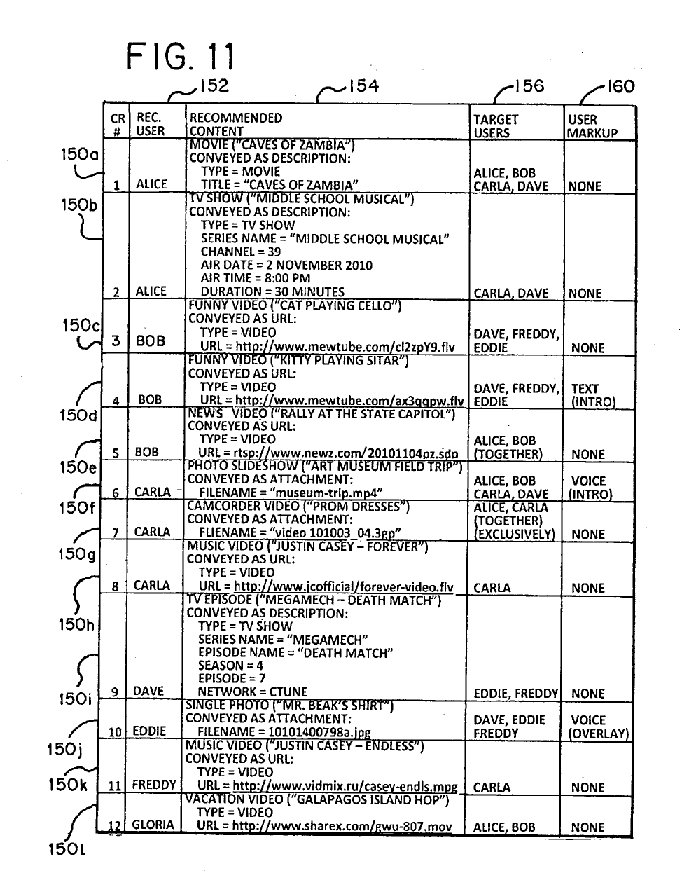

The media experience engine 29 may enable the viewing users 30 to see a list of media content objects associated with one or more of the options and/or to edit the list of media content objects associated with one or more of the options. For example, the media experience engine 29 may display the list of media content objects depicted in FIG. 13 as associated with the second option. The time for each of the media content objects listed in FIG. 13 may include time required to display the media content object and/or additional time, such as, for example, time required to display introductions, transitions, user markup and/or the like.

The media experience engine 29 may enable one or more of the viewing users 30 to select the second option to view a media experience session using the media content objects associated with the second option. Alternatively, the media experience engine 29 may enable one or more of the viewing users 30 to edit the list of media content objects before viewing the media experience session. The editing may remove media content objects from the list, may replace media content objects on the list with other relevant content media content objects, may generate a new media experience session based on media content objects similar to one or more of the media content objects in the list, and/or the like.

For example, Carla may not want to subject her family to Justin Casey music videos and, therefore, may edit the media experience session by instructing the media experience engine 29 to remove the music videos “Justin Casey—Forever” and “Justin Casey—Endless” from the list of media content objects associated with the second option. In response, the media experience engine 29 may remove the music videos “Justin Casey—Forever” and “Justin Casey—Endless” from the list and/or may introduce additional media content objects to replace the music videos. The viewing users 30 may remove the additional media content objects, may perform additional editing of the list of media content objects, and/or may view the media experience session corresponding to the edited list of media content objects.

As a second example of creation of a media experience session, Alice and Bob may sit together for a media experience session while the children Carla and Dave are in their rooms doing homework. The recommendations 150a-150l were not resolved or removed from further consideration before the beginning of the second example. Alice may use the user interface of a media experience engine 29 to request a media experience session with Alice and Bob as the viewing users. Alice may specify that the media experience session be based on the template 410 previously presented as the first example of a template 410, namely the embodiment of the template 410 generally illustrated in FIG. 9b.

The media experience engine 29 may generate a media experience session and/or may begin displaying the media experience session to the viewing users 30, namely Alice and Bob. Alternatively, the media experience engine 29 may present options to the viewing users 30, such as, for example, an option for an alternative media experience session for selection by the viewing users 30 and/or an option for editing of one or more lists of media content objects corresponding to media experience sessions.

In the present example, the media experience engine 29 may generate a media experience session based on the embodiment of the template 410 generally illustrated in FIG. 9b. More specifically, the media experience engine 29 may have, may obtain and/or may generate a service introduction and/or featured media content for the first interval of the template 410. For example, the service introduction and/or the featured media content may be provided by a media experience session service provider which may provide the media experience engine 29. Alternatively, the service introduction and/or the featured media content may be provided by another content provider, such as, for example, a cable TV provider, a satellite TV provider, an IPTV provider and/or the like. The present invention is not limited to a specific provider, and the service introduction and/or the featured media content may be provided may by any provider known to one skilled in the art.

The media experience engine 29 may have, may obtain and/or may generate advertisements for the second time interval, the fourth time interval and/or the sixth time interval of the template 410. For example, the media experience engine 29 may obtain the advertisements from the media experience session service provider, from a third party advertisement service, from an ad server accessible using the internet, and/or the like. The present invention may utilize any source of advertisement content as known to one skilled in the art.

Further, the media experience engine 29 may have and/or may generate a local photo slideshow based on an anniversary date for the fifth time interval of the template 410. For example, the media experience engine 29 may have access to digital photographs which may be stored locally and/or may be hosted on a remote photo sharing service. The digital photographs may be relevant to the viewing users 30, namely Alice and Bob, and/or to the family. The location of the digital photographs in the local network and/or the access information for the remote photo sharing service may have been previously provided to the media experience engine 29. For example, Alice may have specified the location and/or the access information in the user interface provided by the media experience engine 29. The digital photographs may be associated with tags and/or may be available from multiple photo sharing accounts. The tags and/or the accounts may be associated with identities of users of the media experience engine 29. Therefore, the media experience engine 29 may select the digital photographs relevant to the viewing users 30, namely Alice and Bob. Alternatively, the media experience engine 29 may not identify identities of users associated with the digital photographs and/or may select the digital photographs without consideration of identity information.

The digital photographs may be associated with dates; for example, each digital photograph may have a date the photograph was taken, a date the file of the digital photograph was created, a date of last editing, and/or the like. The media experience engine 29 may identify a set of digital photographs associated with a date a number of years in the past. For example, the media experience engine 29 may identify a set of digital photographs taken on the same date one year ago, five years ago, ten years ago, or any number of years ago. The media experience engine 29 may expand the set of digital photographs to include digital photographs taken on a date proximate to the date a number of years in the past. For example, the media experience engine 29 may identify photographs taken within three days of the date one year ago. As a result, the media experience engine 29 may obtain additional digital photographs proximate to the anniversary date if insufficient digital photographs are available on the anniversary date to fill the time interval.

The media experience engine 29 may use the identified set of digital photographs to generate a slideshow which may be presented to the viewing users 30 in the fifth time interval of the template 410. In generating the slideshow, the media experience engine 29 may have an algorithm to select an amount of digital photographs to fill a specified time interval. For example, the media experience engine 29 may select a sufficient number of digital photographs randomly from the identified set of digital photographs. As another example, the media experience engine 29 may create the slideshow of digital photographs by selecting the digital photographs which have tags relevant to the viewing users 30 and/or the digital photographs which have similar tags and/or similar image properties.

The media experience engine 29 may present the slideshow to the viewing users 30. For example, the media experience engine 29 may display a ten second introduction screen with the message “What were we doing one year ago today?” followed by a first set of thirty-four digital photographs displayed sequentially for five seconds each. The first set may be digital photographs created on or near a date one year before the current date. Then, the media experience engine 29 may display another ten second introduction screen with the message “What were we doing five years ago today?” followed by a second set of thirty-four digital photographs displayed sequentially for five seconds each. The second set may be digital photographs created on or near a date five years before the current date. As a result, the media experience engine 29 may create a slideshow which may match the time specification of the time interval, such as, for example, “six minutes,” to match the time specification 411 of the fifth time interval in the template 410.

The media experience engine 29 may employ methods to enhance the slideshow. For example, the media experience engine 29 may utilize a visual transition effect to display the digital photographs. For example, the media experience engine 29 may use a fade-out/fade-in effect, a cross-fade effect, a wipe effect, and/or the like as known to one skilled in the art. As another example, the media experience engine 29 may play music while displaying the digital photographs. For example, the media experience engine 29 may select digital music files which may be available in the local network and/or which may be associated with and/or may be preferred by one or more of the viewing users 30. The present invention is not limited to a specific means for creating visual transition effects or selecting digital music files for the slideshow.

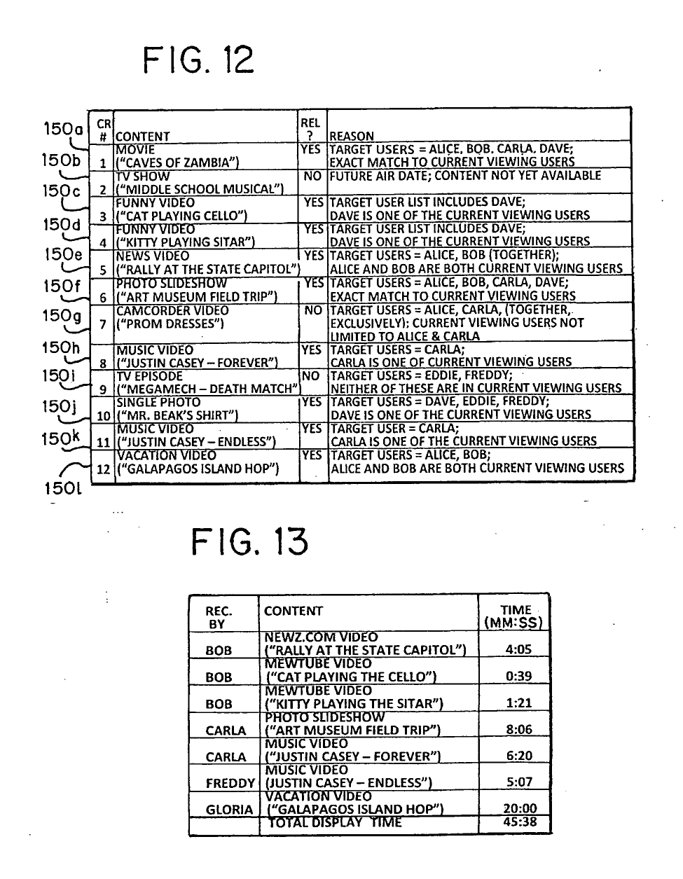

The media experience engine 29 may process the available recommendations 150 to select media content objects for presentation in the third interval and/or the seventh interval of the template 410. In the present example, the media experience engine 29 may have access to the recommendations 150a-150l. The media experience engine 29 may process the recommendations 150a-150l to identify media content objects relevant to the viewing users 30, namely Alice and Bob. For example, the media experience engine 29 may determine relevancy of the media content objects from the recommendations 150a-150l as generally illustrated in FIG. 14. The third column of the table indicates whether each of the media content objects corresponding to recommendations 150a-150j is considered by the media experience engine 29 to be relevant for inclusion in the media experience session requested by Alice for Alice and Bob as the viewing users. The fourth column of the table provides an explanation for each of the relevancy determinations.

The media experience engine 29 may select relevant media content objects from the recommendations 150 for displaying in the third interval and/or the seventh interval of the template 410. In the present example, the third interval and/or the seventh interval of the template 410 may have a time specification of “twenty minutes.” Therefore, the media experience engine 29 may select relevant media content objects to fill two time intervals 409 of approximately twenty minutes each. The media experience engine 29 may use any means of content selection to select relevant media content objects to fill the two time intervals 409, such as, for example, the media content object selection techniques previously set forth.

The media experience engine 29 may identify an insufficient amount of relevant media content objects in processing the recommendations 150 to fill a time interval 409. In this case, the media experience engine 29 may select additional media content objects from one or more available content sources to fill the time interval 409. For example, the media experience engine 29 may select additional media content objects which may be related to the relevant media content objects identified by processing the recommendations 150. The additional media content objects may be provided by the same source as the relevant media content objects identified from the recommendations 150 and/or may be related to the relevant media content objects in other ways. For example, the additional media content objects may be related to the relevant media content objects by having the same or similar subject matter, topic, style, genre and/or the like. The additional media content objects may be related to the relevant media content objects by having a common music artist, music label, actor, actress, director, writer and/or another property identifiable using metadata associated with the media content objects.

The additional media content objects may be identified based on predetermined content preferences of the viewing users 30. If the predetermined content preferences of the viewing users 30 are used to identify the additional media content objects, the additional media content objects may or may not be related to the relevant media content objects of the recommendations 150.

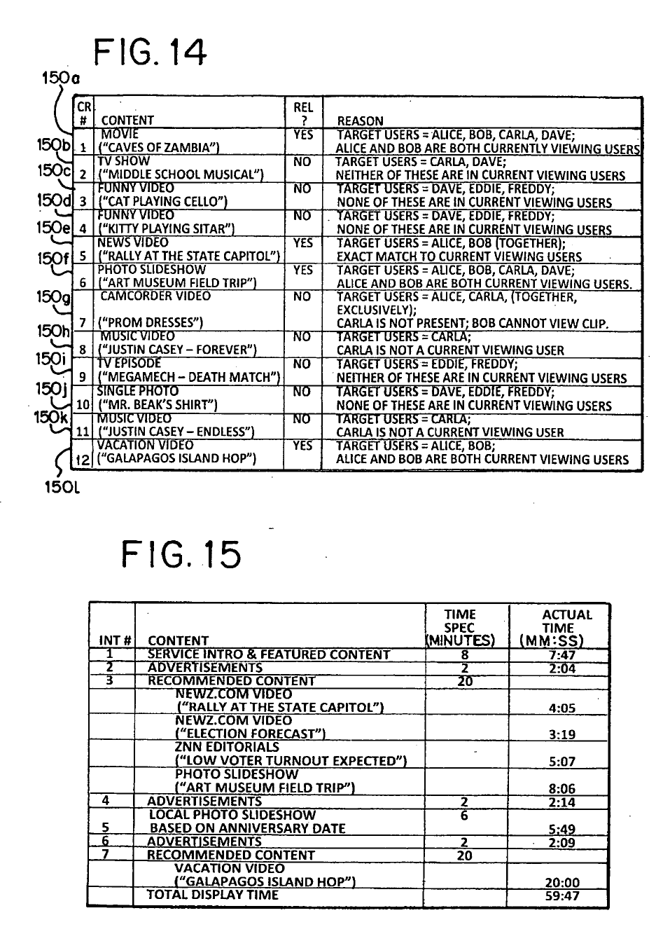

Based on application of the preceding techniques for selection of relevant media content objects, the media experience engine 29 may, for example, propose the following media experience session summarized in FIG. 15 to be viewed by Alice and Bob. In the proposed media experience session depicted in FIG. 15, the media experience engine 29 may select the Newz.com video “Rally at the State Capitol,” the Photo Slideshow “Art museum field trip,” and/or the Vacation Video “Galapagos Island Hop” as relevant media content objects. For example, the media experience engine 29 may select the relevant media content objects by processing the recommendations 150a-150l. Further, the media experience engine 29 may select the relevant media content objects by identifying the media content objects compatible with the third time interval and/or the seventh time interval in the template 410. The media experience engine 29 may determine that the movie “Caves of Zambia” is too long to be compatible with the third time interval and/or the seventh time interval. As previously set forth, the method for matching media content objects to a time interval 409 may vary based on the embodiment.

The media experience engine 29 may have considered various combinations of the relevant media content objects to match the time specifications of the third time interval and/or the seventh time interval according to the media content object selection technique previously set forth. The media experience engine 29 may determine that the Vacation Video “Galapagos Island Hop” is an exact match for one of the time intervals 409, namely the seventh time interval of the template 410 of the present example.

However, the media experience engine 29 may determine that the remaining relevant media content objects available for display, namely the combination of the Newz.com video “Rally at the state capitol” and the Photo Slideshow “Art Museum Field Trip,” is not sufficient to fill the other time interval, namely the third time interval of the template 410 of the present example. Therefore, the media experience engine 29 may search available content sources to identify additional media content objects for display in the other time interval. For example, the media experience engine 29 may identify media content objects related to the Newz.com video “Rally at the State Capitol.”

As shown in FIG. 15, the media experience engine 29 may identify a related video from Newz.com entitled “Election Forecast” and/or an additional related video from another source, namely a ZNN Editorials video entitled “Low voter turnout expected.” These three videos may be related by subject matter; for example, each of the three videos may be associated with subject tags for an upcoming election. More specifically, the media experience engine 29 may identify the two additional video content objects by performing a query search on available content sources using the title, keywords and/or tags associated with the Newz.com video “Rally at the State Capitol”. As a result, the media experience engine 29 may identify media content objects to fill the third time interval and/or the seventh time interval of the template 410.

As previously set forth, the viewing users 30 may interact with the media experience engine 29 to accept the proposed media experience session for viewing. Alternatively, one or more of the viewing users 30 may edit the proposed media experience session before viewing. For example, Alice may use the user interface of the media experience engine 29 to reject all four media content objects proposed for the third time interval. Further, Alice may instruct the media experience engine 29 to display the first twenty minutes of the movie “Caves of Zambia” as replacement media content in the third time interval.

If the media experience engine 29 displays the first twenty minutes of the movie “Caves of Zambia”, the media experience engine 29 may create and/or may modify a record which indicates that Alice and Bob viewed the first twenty minutes of the movie “Caves of Zambia” in the media experience session. As a result, the media experience engine 29 may indicate partial resolution of recommendation 150a associated with the movie “Caves of Zambia.” Further, the media experience engine 29 may create and/or may modify a record which indicates which parts of the movie “Caves of Zambia” were viewed by Alice and Bob. The media experience engine 29 may offer the unviewed portion of the movie “Caves of Zambia” to Alice and/or Bob in a future media experience session. As a result, a portion of a media content object may be viewed in a media experience session, and/or the recommendation 150 associated with the media content object may be partially resolved based on the viewing users 30 who viewed the portion of the media content object.

The preceding examples of creation of a media experience session are not limiting descriptions. The present invention is not limited to specific embodiments of media experience sessions, templates, or methods of selection of media content objects.

Viewing user interaction and viewing of the media experience session are discussed in more detail hereafter. As previously set forth, the media experience engine 29 may enable one or more of the viewing users 30 to request creation, generation and/or presentation of a media experience session for the viewing users 30. The request may specify the viewing users 30 and/or a duration for the media experience session. The request may or may not specify a template 410. The request may specify other parameters, such as, for example, a preferred media content topic, a preference for media content created and/or generated by a specific user, a preference for media content recommended by a specific user, a preference for media content recommended to be viewed by one or more users, a preference for recently recommended media content, and/or the like.

The media experience engine 29 may enable the viewing users 30 to accept a proposed media experience session for viewing and/or to edit a list of media content objects for a proposed media experience session. For example, the media experience engine 29 may enable the viewing users 30 to remove media content objects from a list of media content objects, may enable the viewing users 30 to add media content objects to the list associated with the proposed media experience session, may enable one or more of the viewing users 30 to extend the length of the proposed media experience session, and/or the like.

The media experience engine 29 may enable one or more of the viewing users 30 to create, edit and/or manage the template 410. For example, the user interface of the media experience engine 29 may act as an editing interface by which one or more of the viewing users 30 may add, may delete and/or may edit time intervals 409 in the template 410. The viewing user may create and/or may edit the time specification 411 for each of the time intervals. For example, the viewing user may specify an amount of time, a percentage of the total duration of the media experience session, and/or a range of allowed times which may define the time specification 411 for the time interval 409. Further, the media experience engine 29 may enable the viewing user to create and/or edit the content specification for the time interval. For example, the media experience engine 29 may provide options to require media content objects recommended by a specific user; require media content objects targeting a specific user; require news content objects, sports content objects, weather content objects, music content objects, media content objects of a certain topic, media content objects matching specified tags and/or metadata; and/or the like.

The user interface of the media experience engine 29 may act as a visual editor interface for editing the template 410. For example, the user interface may display the time interval in a form similar to the form depicted in FIG. 9a and/or in tabular form similar to the tables depicted in FIGS. 9b-9d. The media experience engine 29 may enable the viewing user to adjust the time specifications 411 for the time intervals 409 by visually altering graphical representations of the time intervals 409. For example, the end times of the time intervals 409 may be graphically displayed in the visual editor interface and/or may be dragged using a pointer device, such as a mouse and/or a touchscreen. Alternatively, the media experience engine 29 may enable the viewing user to specify the time specifications 411 for the time intervals 409 using other means. For example, the media experience engine 29 may enable the viewing user to enter the time interval 411 using a text entry method, such as a physical keyboard and/or a virtual keyboard. As another example, the media experience engine 29 may enable the viewing user to establish the time intervals 411 by selecting numbers from one or more drop-down menus.

The media experience engine 29 may enable the viewing user to set the content specification 412 by selecting options from one or more drop-down menus, by entering text representing keywords and/or search terms, and/or by other known user interface techniques not specified herein. The present invention is not limited to the examples of the user interface techniques. The present invention may enable the viewing user to specify the time intervals 409, the time specifications 411, and/or the content specifications 412 using any user input methods and/or user interface techniques known to one skilled in the art.

The user interface of the media experience engine 29 may enable a user to specify a scheduled media experience session. For example, the scheduling user may specify a date for the media experience session, a time for the media experience session, and/or a list of one or more of the viewing users 30 expected to be present for the viewing of the media experience session. The scheduling user may provide information about the form and/or the content of the scheduled media experience session. For example, the scheduling user may specify a duration for the scheduled media experience session, and/or the template 410 for generation of the scheduled media experience session.

The scheduling user may specify content preferences for the scheduled media experience session. For example, the scheduling user may specify that the scheduled media experience session is generated based on a live broadcast program and/or event. As a further example, the scheduling user may specify that the scheduled media experience session has media content objects of a specific type and/or form, such as, for example, news content, sports content, media content recommended by one or more recommending users, media content recently recommended, and/or the like.

The user interface of the media experience engine 29 may enable management of the recommendations 150 which may be available to the media experience engine 29 and/or which generation of media experience sessions may consider and/or may use. For example, the user interface may enable a recommending user to list, edit, manage, delete, prioritize and/or mark as resolved the recommendations 150 previously created, previously generated and/or previously submitted by the recommending user. As another example, the user interface may enable a viewing user to list, edit, manage, delete and/or prioritize the recommendations 150 which target the viewing user. In either case, the user interface may enable the user to distinguish the resolved recommendations 150 from the unresolved recommendations 150. Further, the user interface may display a viewing history of media experience sessions for the viewing user. The viewing history may have a list of media content objects viewed by the viewing user, dates and times when the viewing user viewed each of the media content objects in the list, and/or records which may specify the other viewing users who may have viewed the media content objects with the viewing user in a common media experience session.

The media experience engine 29 may enable a viewing user to access previously viewed media experience sessions. For example, the media experience engine 29 may enable the viewing user to replay a previously viewed media experience session, edit a previously viewed media experience session so that the edited version may be viewed by the viewing user and/or other viewing users, and/or generate a recommendation 150 which may recommend a previously viewed media experience session to be viewed by one or more target users. As a result, media experience sessions may be tracked by the media experience engine 29 and/or related components, such as, for example, the media experience support server 60. Previously generated and/or viewed media experience sessions may be used as media content which may be directly viewed. Generation of future media experience sessions may be based on the previously viewed media experience sessions.

The media experience engine 29 may enable a user to create and/or edit a personal profile associated with the user. For example, the media experience engine 29 may enable the user to specify content preferences. Then, the content preferences may be used by the media experience engine 29 for selecting media content objects for a media experience session having the user as one of the viewing users 30. As another example, the media experience engine 29 may enable the user to specify an address book which may define target users to whom the user expects to recommends media content. The address book may define groups of users, such as, for example, a “My Family” group, a “My Kids” group, a “Bridge Club” group, and/or the like, to whom the user expects to recommend media content. The address book may be displayed in the user interface of the media experience engine 29, on the media-capable devices of the user, and/or in the media discovery tools of the user to facilitate specification of the list of target users when the user generates recommendations 150.

The media experience engine 29 may enable a user to create, edit and/or manage records which may identify and/or may specify content sources available to the media experience engine 29. The content sources may provide media content objects for use in media experience sessions. The content sources may be, for example, local content sources, internet content providers, content sharing sites, television service providers, video on demand services, and/or the like. The content sources are not limited to these examples, and the content sources may be any content sources which may be accessible to the media experience engine 29.

The records which may identify and/or may specify the content sources may be and/or may have, for example, a storage location in the local network, a URL, a directory path, an IP address, a domain name, and/or the like. For some content sources, the records may be and/or may have account information, such as, for example, a username, a unique identifier, a password, and/or other credentials which may be required to access the media content objects available from the content source. For some content sources, the records may be and/or may have payment information, such as, for example, an account number, a payment method, a credit card number, a PayPal account, and/or other means for identifying, accessing and/or using a payment method which may be necessary for purchasing, renting, and/or accessing media content objects from a content source which requires payment. For some content sources, the records may be and/or may have rules and/or preferences for authorizing payment. For example, the records may specify whether a media experience engine 29 is authorized to automatically purchase media content objects for a media experience session and/or whether the media experience engine 29 must request authorization from a specific user and/or one of the viewing users 30 to authorize payment for accessing media content objects from a content source which requires payment.

The media experience engine 29 may enable a media experience session to be viewed in multiple locations simultaneously. For example, the media experience session may be viewed by some of the viewing users 30 in one location while the media experience session is viewed by other viewing users 30 in another location. The viewing users 30 in the different multiple locations may communicate with each other to request and/or schedule the media experience session. For example, the media experience engine 29 may enable the viewing users to schedule a media experience session in advance to target the viewing users 30. Then, the media experience engine 29, multiple media experience engines 29, and/or a central component, such as, for example, a media experience support server 60, may enable the viewing users 30 to access and/or view the media experience session at the scheduled time at different locations. For example, one of the targeted viewing users may access the scheduled media experience session using a media experience engine 29 provided by a set-top box attached to a living room television while another of the targeted viewing users may access the scheduled media experience session using a media experience engine 29 accessed using a web-based interface which enables display of the audiovisual content of the media experience session in a web browser.

In a preferred embodiment, the viewing users 30 may access and/or may view the media experience session simultaneously from the different locations and/or may communicate during access and/or viewing of the media experience session. For example, the media experience engines 29 which provide the media experience session may enable the viewing users 30 to enter text comments about the media content objects of the media experience session. The text comments may be transmitted to and/or may be displayed for the other viewing users 30 in the other locations. As another example, the media experience engines 29 which provide the media experience session may enable the viewing users 30 to speak audio comments into a microphone and/or record audiovisual comments using a camera and/or a microphone. The audio comments and/or the audiovisual comments may be transmitted to and/or may be played for the other viewing users 30 in the other locations. The present invention is not limited to these examples of creating, transmitting and/or displaying communications about the media content objects of the media experience session, and the present invention may use any communication method known to one skilled in the art to create, transmit and/or display communications about the media content objects of the media experience session.

The media experience engine 29 may create, may generate and/or may transmit messages which invite targeted viewing users 30 to access, view and/or attend a media experience session. The messages may provide a method for the targeted viewing users 30 to access, view and/or attend the media experience session. For example, the media experience engine 29 may transmit email messages which invite the targeted viewing users 30 to access, view and/or attend a media experience session. The media experience session may be a scheduled media experience session and/or a media experience session requested by one of the viewing users 30 for immediate viewing. The email message may provide a media experience session identifier which may enable a recipient of the email message to access, view and/or attend the media experience session. For example, the email messages may provide a unique identifier which may be entered into the user interface of a media experience engine 29 and/or may provide a URL which may provide access of the media experience session using a web page.

The media experience engine 29 may determine when the viewing users 30 join and/or leave a media experience session. For example, the user interface of the media experience engine 29 may enable each of the viewing users 30 to update a list of the viewing users 30 currently present in the media experience session. As another example, the media experience engine 29 may detect that the viewing users 30 associated with one of the different viewing locations ceased viewing the media experience session. For example, the viewing users 30 associated with one of the different viewing locations may turn off the media rendering device 31 providing the media experience session, may close the browser for a web-based media experience session, may indicate in the user interface of the media experience engine 29 that the session should be ended, and/or the like. As a result, the media experience engine 29 may determine full resolution and/or partial resolution of the recommendations 150 based on which of the viewing users 30 viewed which portions of a media experience session. The media experience engine 29 may invite a viewing user to view the remaining portion of an interrupted media experience session at a later date when the viewing user is available to view the remaining portion of the interrupted media experience session. The present invention is not limited to these examples of means for determination of when the viewing users 30 join and/or leave a media experience session, and the media experience engine 29 may use other means to determine when the viewing users 30 join and/or leave a media experience session.

The preceding examples describe the media experience engine 29 which may generate media experience sessions which may provide media content objects to consumers for information, entertainment and/or personal enjoyment. For example, the media content objects may be news content objects, sports content objects, television programming, movies, internet video clips, music, music videos, digital photographs, camcorder footage, news articles, and/or the like. However, the present invention is not limited to the preceding use cases. The media experience engine 29 may generate media experience sessions for purposes which are not directed to the delivery of information and/or entertainment content to a home network.

For example, the media experience engine 29 may generate media experience sessions in an educational setting. An educational institution, such as, for example, a high school, a college, a university and/or the like may employ an embodiment of the media experience engine 29 to organize and/or promote viewing of educational materials by students and/or staff of the educational institution. The educational institution may be a traditional institution with a physical campus or the educational institution may be a non-traditional institution which lacks a physical campus. For example, the educational institution may be an online degree program.

The educational institution may provide one or more media experience engines 29 to students of the educational institution. For example, each of the students may have a networked device providing the media experience engine 29, and the networked device may attach to a television in their home and/or dorm room. As another example, the students may access a media experience engine 29 which may display media content objects in a web browser on a personal computer, a laptop PC and/or a portable device. As yet another example, the educational institution may provide dedicated media experience stations for use by the students. For example, the campus may have a “media experience lab” where the students may individually or in groups gather to request, generate, edit and/or view the media experience sessions.

The educational institution may provide filmed lectures, classes, coursework and/or the like as audio content and/or video content viewed in a media experience session. For example, the lectures for a class at an online university may be filmed for and/or may be provided in media experience sessions for the students. Then, a teacher, an administrator and/or another staff member of the educational institution may be a recommending user who generates a recommendation 150 which recommends the lectures to the students registered for the class. As a result, the students may be the viewing users 30 assigned to watch lectures, classes, coursework and/or the like using the recommendations 150. Further, the educational institution may determine which students viewed the lectures, the classes and/or the coursework using the preceding techniques for tracking and resolving the recommendations 150. Moreover, the educational institution may determine which portions of the lectures, the classes and/or the coursework were viewed by each of the students using the preceding techniques for tracking and resolving the recommendations 150.

The educational institution, the teachers and/or the other staff members may use the recommendations 150 to recommend additional materials to the entire class of students or to specific students in need of the additional materials in certain areas. The additional materials may be created and/or may be hosted by the educational institution and/or may be references to existing third party content which a teacher believes may be helpful to the understanding of the class and/or the subject matter of the class. For example, a teacher may recommend a television program about physics available on a public broadcasting network video website to three students having trouble with basic physics concepts taught in the class. The teacher may believe that the television program about physics may provide an alternative and/or beneficial explanation of concepts which the three students are experiencing difficulty in learning through the regular class lectures.

The recommendations 150 may have a due date. For example, a teacher may require the students in a class to view a specific coursework video by a specific date. Further, the coursework video and/or other recommended media content may instruct the students to take further actions, such as, for example, to complete an assignment by a specific date.

The educational institution may use the media experience engine 29 in other ways to communicate information to students. For example, the central administration of the educational institution may recommend an orientation video to all incoming students in a certain year and/or may recommend a video about student loans to students below a specified income level. As another example, the central administration may have videos about majors, departments, campus clubs, campus resources, dormitories, services and/or the like, and each of the videos may be recommended to students as needed. Distribution of information using the media experience engine 29 may be preferable to distribution of information using traditional paper packets and mailings because audiovisual presentation may be more effective and/or may be memorable. Further, the educational institution may be able to determine whether the students view the information provided by the recommendations 150.

Students of the educational institution may gather together to request a common media experience session. For example, four friends with some common classes may gather in one location and/or request a media experience session appropriate for the four friends. As a result, the media experience engine 29 may identify unresolved recommendations 150 which may provide lectures, coursework videos, assignments and/or other materials that the four friends may view together to resolve the recommendations 150 and/or to complete common assignments and/or coursework requirements. As a result, the four friends may help each other to understand the material by discussing the content together as the content is viewed. The media experience engine 29 and/or the media rendering device 31 may provide controls to pause, rewind, fast forward and/or otherwise control the presentation of the media content to facilitate discussion and/or exploration of the material during the viewing of the media experience session.

The use of the media experience engine 29 in an educational setting is not limited to assignment of recommendations 150 to students. For example, the media experience engine 29 may be used to communicate recommended media content from students to teachers, staff members and/or other students. For example, after a student completes viewing a lecture, the student may be required to answer a set of questions based on the lecture to verify the student was attentive and/or to promote learning by the student. A camera and/or a microphone may record the answers to the questions, and/or audiovisual footage of the student answering the questions may be recommended for viewing by the teacher. For example, the media experience engine 29 used by the student to view the lecture and/or to record the audiovisual footage may automatically generate a recommendation 150. The recommendation 150 may reference the audiovisual footage and/or recommend viewing of the footage to the teacher of the class. As a result, the media experience engine 29 may be used to organize and/or present lectures and/or coursework to the students. Further, the media experience engine 29 may be used to organize and/or present student-generated content to the teachers and/or other staff of the educational institution. Student-generated content may be, for example, answers to homework questions, quiz answers, questions about the coursework, requests for additional materials and/or help sessions, and/or the like.

Homework assignments may be recommended to students with the requirement that the assignments be viewed and/or completed individually by each of the students. Therefore, the media experience engine 29 may only present the homework assignments if a media experience session is requested by a single viewing user. Then, the student may view the assignment, and the media experience session may accept and/or may record student-generated content to complete the assignment.

As another example, the media experience engine 29 may generate media experience sessions in a business setting. Similar to the educational setting, a business may use the media experience engine 29 to distribute audiovisual materials to employees, to enable efficient viewing of the audiovisual materials by groups of employees, and/or to determine which employees have viewed the audiovisual materials using the techniques for tracking resolution of recommendations 150 previously set forth. The media experience engine 29 may be used to organize and/or manage meetings. The media experience engine 29 may distribute recorded meetings to employees who did not attend and/or employees to whom conclusions and/or results from the meeting may be relevant.

As a first example of use in a business setting, the human resources department of the Acme corporation may prepare media content which may summarize changes to the benefits program of Acme corporation. The changes may be implemented on Jan. 1, 2011, and the human resources department may require the employees to view the changes before Dec. 15, 2010. Therefore, the human resources department may be a recommending user and/or may generate a recommendation 150 for the employees to view the benefits changes presentation. The recommendation 150 may specify a due date of Dec. 15, 2010 for viewing of the media content summarizing the changes. Then, the human resources department may schedule meetings at each of the three physical office locations of the Acme corporation for common viewing of the media content summarizing the changes. For example, the meetings may occur on December 5th at each of the three physical office locations. The attendance of the meetings may be provided to the media experience engine 29 to resolve the recommendations 150 for those employees who viewed the media content summarizing the changes in the meetings.

The remaining employees have unresolved recommendations 150 associated with the media content summarizing the changes. Each of the remaining employees may resolve the recommendation for the media content summarizing the changes by viewing the media content summarizing the changes in a media experience session. Further, a media experience engine 29 may prioritize viewing of the media content summarizing the changes based on the due date. The media experience engine 29 may provide an employee with a reminder of the approaching due date. For example, the media experience engine 29 may display a message when the employee is requesting a media experience session and/or when the employee is in a group of viewing users which requests a media experience session. Alternatively, the media experience engine 29 may remind the employee of the approaching due date by other communication channels. For example, the media experience engine 29 may send an email message and/or an SMS message to the employee. As another example, the media experience engine 29 may use an associated scheduling program to schedule a viewing time for the media content summarizing the changes in the employee's calendar. The scheduled viewing time may, for example, have a direct URL and/or other link to view the media content summarizing the changes using a web-based media experience engine 29.

To extend the first example of use in a business setting further, Bob may organize a meeting and/or may invite Manny, Nora, Ozzie and Patricia to attend. The meeting invitation may be, may represent and/or may generate a recommendation 150 to attend and/or view the meeting. The meeting and/or the contents of the meeting may be recorded for later viewing. For example, the meeting room may have one or more cameras and/or microphones to record the meeting. The one or more cameras and/or microphones of the meeting room may be connected to the media experience engine 29 so that the recorded meeting may be used in and/or referenced by recommendations 150.

At the time of the meeting, Ozzie is out of town and Patricia is called into a more important meeting. Therefore, the meeting attendance is limited to Bob, Manny and Nora. Bob may specify the meeting attendance in the user interface of the media experience engine 29 which may manage the meeting. Therefore, the recommendation associated with the meeting may be partially resolved because Bob, Manny and Nora are recorded as attending the meeting. However, Ozzie and Patricia are not specified in the meeting attendance, and the recommendation 150 for Ozzie and Patricia to attend and/or view the meeting may remain unresolved. Further, Bob may realize during the meeting that two additional employees, namely Randy and Sarah, should be added to the discussion topic for which the meeting was organized. Before the meeting adjourns, Bob may generate an additional recommendation 150 which may recommend the meeting to Randy and/or Sarah.

The content of the meeting may be recorded for later viewing, and the recorded meeting may have unresolved recommendations 150 which may target Ozzie, Patricia, Randy and/or Sarah. Later, Patricia and Sarah are discussing the meeting topic in Patricia's office. They may request a media experience session specifying themselves as the viewing users 30. Then, the media experience engine 29 may propose a common media experience session to view the recorded meeting. As a result, the recommendations 150 to view the recorded meeting may be resolved with respect to Patricia and/or Sarah. Further, Bob may access the user interface of the media experience engine 29 to determine which of the recommendations 150 remain unresolved. As a result, Bob may determine which employees have attended and/or viewed the meeting, namely Bob, Manny, Nora, Patricia and Sarah, and/or which employees to which the meeting was targeted who have not attended or viewed the meeting, namely Ozzie and Randy.

Accordingly, the media experience engine 29 may enable greater cooperation, communication and/or synergy in the viewing of audiovisual materials. The audiovisual materials may be and/or may have, for example, administrative content; professional education content; company information; recorded meetings; employee-generated content, such as, for example, voice messages and/or visual messages; and/or the like. For example, the media experience engine 29 may provide meeting content to employees who cannot attend the meeting. As another example, the media experience engine 29 may enable determination of the targeted employees who have viewed content objects, such as, for example, recorded meetings, and the targeted employees who have not viewed the content objects.

The media experience engine 29 may provide efficiency by encouraging group viewing and/or group discussion of content objects. For example, employees may gather in a group and/or may request a media experience session. As a result, the media experience engine 29 may generate a media experience session which combines media content recommended to be viewed in common by the employees which gather to request the media experience session.

Further, the media experience engine 29 may automatically schedule meetings for employees to view commonly recommended media content. Using the previous example, Bob may establish a due date for the target employees to view the meeting by Dec. 7, 2010. As a result, the media experience engine 29 may organize and/or may schedule a common meeting for employees with unresolved recommendations 150 to view the meeting, and the common meeting may occur before the due date. For example, the media experience engine 29 may communicate with a scheduling program to create a meeting invitation on Dec. 5, 2010 directed to Ozzie and Randy. The media experience engine 29 may communicate with the scheduling program to reserve a meeting room in which Ozzie and/or Randy may view the recorded meeting. Comments and/or questions from Ozzie and/or Randy about the meeting material may be recorded. As a result, the comments or questions may be automatically recommended for viewing by the meeting organizer, namely Bob, and/or by other employees who previously attended and/or viewed the meeting.

The present invention is not limited to use in information, entertainment, education and business settings. The present invention and the techniques disclosed herein may be applied to any setting where users would benefit from a common framework for generating the recommendations 150 and/or for generating media experience sessions based on the recommendations 150.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A method for recommending media content using a media experience engine, the method comprising the steps of:
generating a request for a media experience session wherein the request identifies a plurality of viewing users;
receiving the request wherein the media experience engine receives the request;
accessing a database of recommendations wherein the media experience engine accesses the database and further wherein each of the recommendations specifies a recommending user who submitted the recommendation, a media content object referenced by the recommendation, and one or more target users;
selecting a first set of media content objects based on the recommendations wherein the media experience engine selects the first set of media content objects to have each media content object of the first set referenced by at least one recommendation which specifies at least one target user in the plurality of viewing users;
generating the media experience session which arranges the first set of media content objects on a timeline; and
viewing the media experience session wherein the plurality of viewing users view the first set of media content objects in the media experience session.

2. The method of claim 1 further comprising the step of:
specifying a duration for the media experience session wherein the request specifies the duration and further wherein the media experience engine generates the media experience session based on the duration.

3. The method of claim 1 further comprising the step of:
specifying a first recommending user wherein the request specifies the first recommending user and further wherein the media experience engine selects the first set of media content objects to have each media content object of the first set referenced by at least one recommendation submitted by the first recommending user.

4. The method of claim 1 further comprising the step of:
specifying a template for the media experience session wherein the template specifies requirements for arranging media content on the timeline and further wherein the media experience engine generates the media experience session based on the template.

5. The method of claim 4 wherein the template specifies a first time interval on the timeline and a second time interval on the timeline and further wherein the media experience engine arranges the first set of media content objects in the first time interval on the timeline wherein the media experience engine arranges a second set of media content objects in the second time interval on the timeline.

6. The method of claim 1 further comprising the step of:
recording first information which specifies first participating users of the viewing users wherein the first participating users participated in at least a portion of the media experience session and further wherein the first information specifies the media content objects viewed by the first participating users during the media experience session wherein the media experience engine records the first information;
recording second information which specifies second participating users of the viewing users wherein the second participating users participated in at least a portion of a previous media experience session which occurred before the media experience session and further wherein the second information specifies the media content objects viewed by the second participating users during the previous media experience session; and
determining whether a first recommendation of the recommendations is resolved wherein the first information and the second information are used to determine whether the first recommendation is resolved and further wherein the first recommendation is resolved if each of the one or more target users specified by the first recommendation viewed the media content object referenced by the first recommendation.

7. The method of claim 1 further comprising the step of:
specifying the media content object using a URL wherein a first recommendation of the recommendations specifies the media content object referenced by the first recommendation using the URL.

8. The method of claim 1 further comprising the step of:
specifying the media content object using descriptive information wherein a first recommendation of the recommendations specifies the media content object referenced by the first recommendation using the descriptive information and further wherein the first recommendation does not specify a location for accessing the media content object.

9. The method of claim 1 further comprising the step of:
identifying additional media content objects not referenced by the recommendations wherein the media experience engine identifies the additional media content objects and arranges the additional media content objects on the timeline and further wherein the media experience session has the first set of media content objects and the additional media content objects.

10. The method of claim 1 wherein the plurality of viewing users view the media content of the media experience session simultaneously on the same media rendering device.

11. The method of claim 1 wherein a first viewing user of the plurality of viewing users views the media content of the media experience session on a first media rendering device and further wherein a second viewing user of the plurality of viewing users views the media content of the media experience session on a second media rendering device which is a different device than the first media rendering device.

12. The method of claim 1 further comprising the step of:
viewing the media content of the media experience session wherein a first viewing user of the plurality of viewing users views the media content of the media experience session and further wherein a second viewing user of the plurality of viewing users views the media content of the media experience session at a time subsequent to viewing of the media content of the media experience session by the first viewing user.

13. The method of claim 1 further comprising the step of:
accepting user input from the plurality of viewing users which prompts the media experience engine to perform an action which modifies the media experience session wherein the action is one of adding an additional media content object to the media content of the media experience session, removing a selected media content object from the media content of the media experience session, and selecting an alternative media experience session having a different media content object than the media experience session.

14. The method of claim 1 further comprising the step of:
submitting a first recommendation after viewing the media experience session wherein the media content object referenced by the first recommendation is the media experience session and further wherein at least one of the one or more target users specified by the first recommendation is not in the plurality of viewing users.

15. A method for recommending media content using a first media-capable device having a user interface, the method comprising the steps of:
identifying a first media content object wherein a first recommending user identifies the first media content object using the user interface of the first media-capable device;
accepting user input in the user interface of the first media-capable device wherein the user input requests generation of a recommendation and specifies one or more first target users;
generating a first recommendation which specifies the first media content object and the one or more first target users wherein the media-capable device generates the first recommendation in response to the user input;
generating a media experience session for a plurality of viewing users wherein the media experience session arranges media content objects on a timeline; and
selecting the first media content object for inclusion in the media experience session based on a comparison between the plurality of viewing users and the one or more first target users specified by the first recommendation.

16. The method of claim 15 further comprising the step of:
viewing the media content of the media experience session wherein the plurality of viewing users view the media content of the media experience session simultaneously on the same media rendering device.

17. The method of claim 15 further comprising the step of:
generating a request wherein one of the plurality of viewing users generates the request and further wherein the request identifies the plurality of viewing users wherein the media experience session is generated in response to the request.

18. The method of claim 15 further comprising the step of:
transmitting the first recommendation and a second recommendation to a media experience engine wherein the media experience engine generates the media experience session based on processing of the first recommendation and the second recommendation.

19. The method of claim 15 further comprising the step of:
transmitting the first recommendation wherein the first media capable device transmits the first recommendation in a message and further wherein the message has the first media content object.

20. The method of claim 15 further comprising the step of:
accessing the first media content object using a URL wherein the first recommendation specifies the URL and further wherein the media content object is accessed for inclusion in the media experience session using the URL.

21. The method of claim 15 further comprising the steps of:
specifying the media content object using descriptive information wherein the first recommendation specifies the first media content object using the descriptive information and further wherein the first recommendation does not specify a location for accessing the first media content object;
receiving the first recommendation wherein a media experience engine receives the first recommendation;
querying a content source using the descriptive information wherein the media experience engine queries the content source wherein the content source identifies a first location for accessing the first media content object in response to the query; and
accessing the first media content object for inclusion in the media experience session using the first location.

22. The method of claim 15 further comprising the steps of:
accepting text input in the user interface wherein an application with recommendation capabilities accepts the text input from the first recommending user wherein the text input is descriptive of the first media content object and further wherein identification of the first media content object is based on the text input; and
specifying the media content object using the text input wherein the first recommendation specifies the first media content object using the text input.

23. The method of claim 15 further comprising the step of:
generating user markup on the first media-capable device wherein the user markup is associated with the first media content object and further wherein the user markup is one of a text comment, an audio comment and a video comment wherein the first recommendation has the user markup and further wherein the user markup is rendered for the plurality of viewing users during the media experience session.

24. The method of claim 15 further comprising the steps of:
identifying a second media content object using a second media-capable device which is a different device than the first media-capable device wherein the first recommending user identifies the second media content object;
generating a second recommendation which specifies the second media content object and one or more second target users wherein the second media-capable device generates the second recommendation; and
selecting the second media content object for inclusion in the media experience session based on a comparison between the plurality of viewing users and the one or more second target users specified by the second recommendation.

25. The method of claim 15 further comprising the steps of:
identifying a second media content object using the first media-capable device wherein a second recommending user who is a different user than the first recommending user identifies the second media content object; and
generating a second recommendation which specifies the second media content object and one or more second target users wherein the first media-capable device generates the second recommendation at the direction of the second recommending user wherein the second recommendation specifies the second recommending user as the user who submitted the second recommendation and further wherein the first recommendation specifies the first recommending user as the user who submitted the first recommendation.

26. The method of claim 15 further comprising the step of:
specifying a requirement which is one of a requirement that the one or more first target users view the first media content object together in the same media experience session and a requirement that the one or more first target users be the exclusive viewers of the first media content object wherein the first recommendation specifies the requirement at the direction of the first recommending user.

27. The method of claim 15 further comprising the step of:
selecting the one or more first target users wherein the first recommending user selects the one or more first target users from a list wherein the list displays at least one individual user and at least one group of users.

28. The method of claim 15 further comprising the step of:
simultaneously displaying a web page and a list of target users in the user interface wherein the first media content object is provided by the web page and further wherein the first recommending user selects the one or more target users from the list of target users.

29. The method of claim 15 further comprising the step of:
simultaneously displaying a web page, a list of target users, and symbolic representations of a plurality of media content objects provided by the web page wherein the user interface simultaneously displays the web page, the list of target users and the symbolic representations and further wherein the first recommending user selects the one or more first target users from the list of target users wherein the first recommending user identifies the first media content object by selecting the symbolic representation corresponding to the first media content object using the user interface.

30. The method of claim 15 further comprising the step of:
displaying a list of media content objects previously accessed in a web browser wherein the list of media content objects is displayed in the user interface by an application with recommendation capabilities wherein the application with recommendation capabilities is a different application than the web browser and further wherein the first recommending user identifies the first media content object using the list.

31. A system for recommending media content, the system comprising:
a first media-capable device which a first recommending user uses to identify a first media content object and one or more first target users;
a first recommendation wherein the first media-capable device generates the first recommendation and further wherein the first recommendation specifies the first media content object and the one or more first target users;
a media experience engine which generates a media experience session for a plurality of viewing users wherein the media experience engine selects media content objects for the media experience session based on a set of recommendations wherein the set of recommendations includes the first recommendation and further wherein the media experience engine selects the first media content object for inclusion in the media experience session based on comparing the one or more first target users to the plurality of viewing users; and
a first media rendering device which displays at least a portion of the media content of the media experience session to at least one of the plurality of viewing users.

32. The system of claim 31 further comprising:
a media experience support server which receives a plurality of recommendations and transmits the first recommendation to the media experience engine wherein the media experience support server is located remotely from the media experience engine.

33. The system of claim 31 further comprising:
a media experience support server which receives the first recommendation, obtains the first media content object based on a specification of the first media content object provided by the first recommendation, and transmits the first media content object to the media experience engine.

34. The system of claim 31 further comprising:
a media experience support server which receives the first recommendation, queries a content source based on a description of the first media content object provided by the first recommendation, receives a URL for accessing the first media content object in response to querying the content source, and transmits the URL to the media experience engine.

35. The system of claim 31 further comprising:
a software application executed by a computing device wherein the software application provides the media experience engine.

36. The system of claim 31 further comprising:
an electronic device at the same location as the first media rendering device and communicatively connected to the first media rendering device wherein the electronic device provides the media experience engine.

37. The system of claim 31 wherein the media experience engine is located remotely relative to the first media rendering device.

38. The system of claim 31 wherein the first media rendering device provides the media experience engine.

39. The system of claim 31 further comprising:
a remote content source accessed by the first media rendering device using the internet wherein the first media content object is transmitted from the remote content source to the first media rendering device by the internet for use in the media experience session.

40. The system of claim 31 further comprising:
a local content source associated with the media experience engine wherein the media experience engine obtains the first media content object from the local content source for use in the media experience session.

41. The system of claim 31 further comprising:
a content source at the same location as the first media rendering device and connected to the first media rendering device by a local area network wherein the first media rendering device uses the local area network to obtain the first media content object from the content source for use in the media experience session.

42. The system of claim 31 further comprising:
a second recommendation generated by a second media capable device wherein the second recommendation identifies a second media content object and one or more second target users wherein the media experience engine selects the second media content object for inclusion in the media experience session based on comparing the one or more second target users to the plurality of viewing users.

43. The system of claim 31 further comprising:
a second media rendering device located remotely from the first media rendering device wherein the second media rendering device displays the media content of the media experience session to a first viewing user of the plurality of viewing users while the first media rendering device simultaneously displays the media content of the media experience session to a second viewing user of the plurality of viewing users.
